(19) United States
(12) Patent Application Publication
(10) Pub. No.: US 2003/0057346 A1
(43) Pub. Date: Mar. 27, 2003

(54) Active vibration isolator and exposure apparatus with the active vibration isolator, device manufacturing method

(76) Inventor: Shinji Wakui, Tochigi (JP)

Correspondence Address: FITZPATRICK CELLA HARPER & SCINTO, 30 ROCKEFELLER PLAZA, NEW YORK, NY, 10112, US

(21) Appl. No.: 09/945,727

(22) Filed: Sep. 5, 2001

(30) Foreign Application Priority Data
Sep. 14, 2000 (JP) 279284/2000

(51) Int. Cl. F16M 13/00; G01N 29/00

(52) U.S. Cl. 248/550; 73/663

(57) ABSTRACT

A method relying on the time response includes acquiring the time response waveforms of all the acceleration sensors obtained when a table for vibration isolating is excited by a pseudo impulse (step S802), making the frequency analysis for the time response waveforms (step S803), calculating a mode matrix φ (step S804), and implementing the mode matrix φ in a non-interacting control system for each vibration mode (step S805). A method relying on the frequency response includes acquiring the frequency responses to all the acceleration sensors, displaying the acquired frequency responses in a Nyquist diagram, obtaining a parameter (φ) fitted to each Nyquist circle, and implementing the obtained parameter φ in a non-interacting control system for each vibration mode.

### FIELD OF THE INVENTION

The present invention relates to an active vibration isolator that employs a non-interacting control system for each vibration mode capable of damping on the basis of a vibration mode for a table for vibration isolating and an exposure apparatus with the active vibration isolator, and a method of manufacturing a device using the exposure apparatus.

### BACKGROUND OF THE INVENTION

In an exposure apparatus represented by an electron microscope using an electron beam or a stepper, an XY stage is mounted on a vibration isolator. This vibration isolator has a function of attenuating the vibration by vibration absorbing means such as an air spring, a coil spring and a vibration proof rubber. However, there is the problem that a passive vibration isolator having the vibration absorbing means can attenuate the vibration propagating from the floor to some extent, but can not attenuate effectively the vibration which the XY stage itself mounted on the vibration isolator gives rise to. That is, a remotion force caused by high speed movement of the XY stage itself might swing the vibration isolator, this vibration remarkably impeding the positioning stabilization of the XY stage. Further, in the passive vibration isolator, there was the problem of a trade-off between the insulation (vibration isolation) of the vibration propagating from the floor and the suppression (damping) performance of the vibration caused by high speed movement of the XY stage itself. In order to solve these problems, there is a trend of employing an active vibration isolator in recent years. The active vibration isolator can resolve the trade-off between the vibration isolation and the damping within the ability of an adjustable mechanism, and in particular apply a feed forward control positively to obtain the performance that the passive vibration isolator can not achieve.

Herein, the active vibration isolator employs a vibration sensor (typically an acceleration sensor but alternatively a velocity sensor) or a position sensor, and the actuator may be an air spring, an electromagnetic actuator, or a piezoelectric element representing a displacement type actuator. Among others, the air spring actuator has the ability to support a table for vibration isolating of large mass, but has a slow response.

On one hand, a linear motor which is representative of the electromagnetic actuator may be increased in size and generate a large quantity of heat to support a massive object. However, the linear motor has quite excellent responsibility as compared with the air spring actuator. Thus, it is common practice that the air spring actuator fulfills a role of supporting the table for vibration isolating of large mass, and the linear motor fulfills a role of suppressing the swing around an equilibrium point of the table for vibration isolating supported by the air spring at high rate. A so-called hybridization is employed. In this case, the air spring actuator has the positional control for orienting the table for vibration isolating.

On the other hand, the linear motor has a feed back loop to produce an operation force as the damping against the mechanical resonance by a support mechanism of the vibration oscillating table.

FIG. 15 shows the constitution of a hybrid active vibration isolator according to the conventional example. In FIG. 15, reference numeral 21 denotes an active support leg for supporting the XY stage mounted on the table for vibration isolating 22, and 23-1, 23-2 and 23-3 denote active support legs for supporting the table for vibration isolating 22. One active support leg 23 contains the acceleration sensors AC, the position sensors PO, the pressure sensors PR, the servo valves SV, the air spring actuators AS and the electromagnetic actuators (e.g., linear motors LM) of a necessary number for controlling two axes in the vertical and horizontal directions. Herein, the symbol (e.g., -Y2) attached after the acceleration sensors AC and the position sensors PO indicates the orientation in a coordinates system in the figure and the arranged position of the active support leg 23. For example, Y2 means the Y-axis direction and belonging to the active support leg 23-2 arranged to the left.

FIG. 16 shows a feed back configuration of the conventional active vibration isolator applied to the table for vibration isolating of FIG. 15. Reference signs PO-Z1, PO-Z2, PO-Z3, PO-X1, PO-Y2, PO-Y3 denote the position sensors as a plurality of position sensor, the outputs being compared with the output signal (Z₁₀, Z₂₀, Z₃₀, x₁₀, y₂₀, y₃₀) of a position target value output section 1 to have a position deviation signal (e_{z1}, e_{z2}, e_{z3}, eₓ₁, e_{y2}, e_{y3}) for each axis. This deviation signal is led to motion mode extracting calculator 2 regarding the position signal for calculating and outputting an motion mode position deviation signal (eₓ, e_{y}, e_{z}, eθₓ, eθ_{y}, eθ_{z}) having a total of six degrees of freedom for translation and rotation of the table for vibration isolating 22. Then, this output signal are led to a PI compensator 3 regarding the position for adjusting the positional characteristic in almost non-interacting manner for each motion mode to generate an motion mode drive signal (dₓ, d_{y}, d_{z}, dθₓ, dθ_{y}, dθ_{z}). Herein, reference sign P denotes a proportional motion, and I denotes an integral motion.

The motion mode drive signal is input into motion mode distributing calculator 4 for generating a drive signal (d_{z1}, d_{z2}, d_{z3}, dₓ₁, d_{y2}, d_{y3}) to determine an internal pressure of the air spring actuator AS for each axis. The air spring actuator AS for each axis is subject to a pressure feedback in an applied pressure feedback as disclosed in JP-A-10-256141. This pressure feedback is configured in the following manner. The internal pressure of the air spring actuator for each axis is measured by each of the pressure sensors PR-Z1, PR-Z2, PR-Z3, PR-X1, PR-Y2 and PR-Y3. The output is fed back via a pressure detector 5 having an appropriate filtering function to the former stage of the PI compensator 6 regarding the pressure. Zero point of a transfer function for the PI compensator 6 regarding the pressure has a first order lag in frequency characteristics ranging from the input voltage into a voltage-current transducer 7 (abbreviated as VI transformation in the figure) for controlling the valve opening or closing of a servo valve SV to feed or exhaust the air that is a working fluid for the air spring actuator AS to the internal pressure of the air spring actuator AS. Therefore, the setting is made to cancel the pole created by the time constant of this first order lag. A signal from a pressure target value output section 8 for determining a target value of the internal pressure for the air spring actuator AS is applied to the former stage of the PI compensator 6 regarding the pressure. This loop is referred to as a pressure feedback loop. To this loop, a drive signal (d_{z1}, d_{z2}, d_{z3}, dₓ₁, d_{y2}, d_{y3}) for each axis that is an output of the motion mode distributing calculator 4 is applied. A loop having this pressure feedback loop as a minor (local) loop for controlling the internal pressure of the air spring actuator AS on the basis of an output from the position sensor PO is referred to as a position control loop.

A vibration control loop for providing damping to mechanical resonance of the active support leg for supporting the table for vibration isolating 22 (FIG. 15) will be described below. A linear motor LM that is representative of the electromagnetic actuator is employed here to suppress the vibration. First of all, the outputs from the acceleration sensors AC-Z1, AC-Z2, AC-Z3, AC-X1, AC-Y2 and AC-Y3 representing the electromagnetic actuator are passed through an appropriate filtering process to remove high frequency noise and promptly input into motion mode extracting calculator 9 regarding the acceleration. Its output is an motion mode acceleration signal (aₓ, a_{y}, a_{z}, aθₓ, aθ_{y}, aθ_{z}). In order to effect optimal damping for each motion mode, the motion mode acceleration signal is led to an integral compensator 10 regarding the acceleration signal at the next stage. Herein, an integral or pseudo-integral operation is performed to provide a speed signal for each motion mode, and produce a signal with a suitable gain for each motion mode. This signal is led to motion mode distributing calculator 11 for producing an input signal into a driver 12 for conducting an electric current to the linear motors LM-Z1, LM-Z2, LM-Z3, LM-X1, LM-Y2 and LM-Y3. In accordance with this output, electric current flows through the linear motors LM to afford damping for each motion mode. A loop for driving the linear motors LM-Z1, LM-Z2, LM-Z3, LM-X1, LM-Y2 and LM-Y3 on the basis of the outputs from the acceleration sensors AC-Z1, AC-Z2, AC-Z3, AC-X1, AC-Y2 and AC-Y3 is herein referred to as the vibration control loop.

As described above (see FIGS. 15 and 16), conventionally, an output from a vibration sensor (here, an acceleration sensor AC) mounted at each location of the table for vibration isolating 22 was passed through the motion mode extracting calculator (matrix calculation) 9 determined on the basis of the geometrical arrangement of the vibration sensor with reference to a center of gravity of the table for vibration isolating 22 to extract an motion mode acceleration signal, which was then compensated individually, and passed through the motion mode distributing calculator (matrix calculation) 11 determined on the basis of the geometrical arrangement of the linear motor LM with reference to the center of gravity of the table for vibration isolating 22 to produce a driving force of each linear motor. In this way, damping was afforded to a support mechanism for the table for vibration isolating 22 for each motion mode. In the conventional damping by the use of the linear motors LM, each matrix of the motion mode extracting calculator 9 or the motion mode distributing calculator 11 is a unit matrix. That is, this damping had a feedback loop independent for each drive shaft such that the output from the acceleration sensor AC located directly close to the linear motor LM is fed back to the linear motor LM. In contrast to the damping independent for each drive shaft with the linear motor LM, the damping for each motion mode has a feature that the attitude of the table for vibration isolating 22 can be finely adjusted, and has greatly contributed to making the most of the ability of the precision mechanical apparatus mounted on the table for vibration isolating 22.

However, a problem with damping for each motion mode arose. The problem was that if the feedback gain of the acceleration signal for each motion mode is adjusted, the damping acts to suppress a main resonance peak contained in the motion mode of notice, but may be applied to other resonance peaks than the main resonance peak in the vibration mode because the damping is applied to the motion mode (i.e., some damping may be given to adjacent other motion modes). With such adjustment of damping, if the damping was adjusted for each motion mode in succession, the damping for the motion mode already adjusted was excessive. Accordingly, as a result that the suppression of the resonance peak is over-damping, it took a considerable time to make convergence for positioning, leading to a slow response. In order to avoid over-damping state in such a positioning waveform, after making the damping adjustment for one series of motion modes, the gain of readjusted motion mode regarding the acceleration had to be adjusted to be weaker.

The problems that the invention is to solve are summarized in the following.

Conventionally, the active vibration isolator employing the air spring actuators and the linear motors simultaneously was operated to give damping by driving the latter actuators in response to the output from the vibration sensor. In this case, the damping was afforded by driving the linear motor in response to a signal having an output from the acceleration sensor mounted in the vicinity of each linear motor compensated appropriately. Alternatively, a loop configuration for each motion mode was employed by extracting an acceleration signal regarding the motion mode of the table for vibration isolating from the output of the acceleration sensor mounted at each location of the table for vibration isolating, the acceleration signal being compensated appropriately for each motion mode, and making the matrix operation in view of the geometrical arrangement of the linear motor with reference to the center of gravity of the table for vibration isolating to distribute a drive command. As compared with the feedback configuration that damping is given independently for each drive shaft, the adjustment of damping can be made more finely by the loop configuration for each motion mode. However, since the damping for each motion mode leads to over-damping, the convergence for positioning may be slower in some cases. To avoid this, it was troublesome that the feedback gain of motion mode regarding the acceleration already adjusted must be readjusted.

The active vibration isolator employing only the air spring as the actuator was also in the same situation. That is, conventionally, damping was given by driving the air spring actuator in response to a signal with an output of the acceleration sensor mounted in the vicinity of each air spring actuator compensated appropriately. Alternatively, a loop configuration for each motion mode was employed by extracting an acceleration signal regarding the motion mode of the table for vibration isolating from the output of the acceleration sensor mounted at each location of the table for vibration isolating, the acceleration signal being compensated appropriately for each motion mode, and making the matrix operation in view of the geometrical arrangement of the air spring actuator with reference to the center of gravity of the table for vibration isolating to distribute a drive command and produce a driving force for damping in the air spring actuator. In this case, like the previous case, since if damping is given for each motion mode, over-damping results, the convergence for positioning may be slower. To avoid this, it was troublesome that the feedback gain of motion mode regarding the acceleration already adjusted must be readjusted.

### SUMMARY OF THE INVENTION

The present invention has been proposed to solve the conventional problems, and has as its object to provide an active vibration isolator and an exposure apparatus employing the active vibration isolator, in which the attitude of a table for vibration isolating can be adjusted suitably without causing over-damping, and consequently without need of readjusting the feedback gain of the motion mode regarding the acceleration already adjusted.

Also, it is another object of the invention to provide a mode matrix calculation method, an active vibration isolator, and an exposure apparatus employing them, the calculating method being capable of calculating a mode matrix simply, in a short time and at high precision to implement a non-interacting control system for each vibration mode having the advantage of adjusting the damping in individual and non-interacting manner with respect to an inherent vibration mode of the table for vibration isolating supported by the active vibration isolator.

It is a further object of the invention to provide a control system constituting a vibration control loop in the active vibration isolator for each vibration mode, instead of the conventional motion mode. It is a still further object of the invention to establish a calculation method for calculating a mode matrix φ in a short time and at high precision.

The present inventors have found that the above objects can be achieved by the following means, as a result of examination in trial and error to accomplish the above objects, and have completed the present invention.

In order to accomplish the above objects, according to one aspect of the invention, there is provided an active vibration isolator comprising a table for vibration isolating, a plurality of actuators for driving the table for vibration isolating, a plurality of vibration sensor for detecting a vibration of the table for vibration isolating, and a plurality of position sensor for detecting a displacement of the table for vibration isolating, wherein the table for vibration isolating is actively damped by driving the plurality of actuators on the basis of a state quantity fed back through a vibration control loop for each vibration mode that is non-interacting on the basis of the outputs of the vibration sensor, and a position control loop for each motion mode on the basis of the outputs of the position sensor and damping the vibration mode that is non-interacting.

Herein, the vibration mode is an inherent resonance mode of the table for vibration isolating supported. And the motion mode involves an exciting motion in a state where the translation in a direction parallel to each axis occurs along with the rotation around each axis, when a rectangular coordinate system is defined in the table for vibration isolating.

Preferably, the active vibration isolator according to the invention comprises vibration mode extracting calculator for converting an motion mode acceleration signal into a vibration mode acceleration signal, and vibration mode distributing calculator for converting into a drive signal for giving rise to damping for an motion mode, wherein damping can be effected for each vibration mode.

Preferably, the active vibration isolator according to the invention comprises the plurality of actuators consisting of a plurality of air spring actuators and a plurality of electromagnetic actuators, the electromagnetic actuators being driven through the vibration control loop for each vibration mode, and the air spring actuators being driven through the position control loop for each motion mode.

Preferably, the active vibration isolator according to the invention comprises the plurality of actuators consisting of a plurality of air spring actuators, the air spring actuators being driven through the vibration control loop for each vibration mode, and through the position control loop for each motion mode.

Further, in the active vibration isolator according to the invention, the vibration sensor is an acceleration sensor or a velocity sensor.

In any of the active vibration isolators as described above, the vibration control loop is configured in the following way. That is, the vibration control loop is composed of collective vibration mode extracting calculator for calculating a vibration mode of the table for vibration isolating on the basis of the outputs of a plurality of vibration sensor, a compensator for making appropriate compensation for an output of the vibration mode extracting calculator, and collective vibration mode distributing calculator for distributing a drive signal to produce a driving force in a region of an actuator arranged practically by inputting a signal of the compensator.

Herein, the vibration mode extracting calculator may be realized collectively as described above, or by connecting in cascade the motion mode extracting calculator for extracting the motion mode of the table for vibration isolating from an output of the vibration sensor and the vibration mode extracting calculator for calculating the vibration mode employing an output of the motion mode extracting calculator.

Similarly, the vibration mode distributing calculator may be realized collectively as described above, or by inputting an appropriate output of the compensator, firstly passing it through the vibration mode distributing calculator for calculating a drive signal of the motion mode, and secondly through the motion mode distributing calculator for distributing a drive signal to drive an actuator for each axis. However, when the air spring actuator is only employed, the vibration mode distributing calculator may be used.

Further, the active vibration isolator according to the invention further comprises a mode calculator for calculating a mode matrix of the each vibration mode based on at least one detection result of the vibration sensor and the position sensor.

Further, in the active vibration isolator according to the invention, the mode calculator measures a time response waveform of the table for vibration isolating to an input of a pseudo impulse by the vibration sensor or the position sensor, analyzes frequencies of the time response waveform and calculates the mode matrix of the table for vibration isolating from the frequencies analysis.

Further, in the active vibration isolator according to the invention, the time width of the pseudo impulse is a spectrum for applying an equal excitation force in the vibration mode for said table for vibration isolating supported by said actuators.

Further, in the active vibration isolator according to the invention, the mode calculator measures a response to the vibration sensor or said position sensor as a frequency response from a sweep sinusoidal wave signal, calculates a parameter in a dynamic system with one degree of freedom to convert the frequency response into a Nyquist diagram and make curve fitting to a number of circles equal to at least the number of vibration modes for the table for vibration isolating appearing in the Nyquist diagram and calculates the mode matrix from the result of the curve fitting.

Further, in the active vibration isolator according to the invention, the actuator includes an electromagnetic actuator.

Further, the active vibration isolator according to the invention further comprises vibration mode extracting calculator for extracting a vibration mode of the table for vibration isolating from the outputs of the plurality of vibration sensor and vibration mode distributing calculator for distributing a signal with an output of the vibration mode extracting means compensated appropriately to the actuators, wherein the compensation for the output of said vibration mode extracting means by the vibration mode distributing calculator is adjustment of damping for a resonance peak of each vibration mode on the basis of the calculated mode matrix.

According to a still further aspect of the invention, there is provided an exposure apparatus for transferring a circuit pattern formed on an original plate via a projection optical system onto a photosensitive substrate on a substrate stage, comprising an active vibration isolator in the exposure apparatus, wherein the active vibration isolator comprises a table for vibration isolating, a plurality of actuators for driving the table for vibration isolating, a plurality of vibration sensor for detecting a vibration of the table for vibration isolating, and a plurality of position sensor for detecting a displacement of the table for vibration isolating, wherein the table for vibration isolating is actively damped by driving the plurality of actuators on the basis of a state quantity fed back through a vibration control loop for each vibration mode that is non-interacting on the basis of the outputs of the vibration sensor, and a position control loop for each motion mode on the basis of the outputs of the position sensor and damping the vibration mode that is non-interacting.

A semiconductor device manufacturing method of the invention comprises a step of installing a plurality of manufacturing apparatus for semiconductor process including an exposure apparatus in a semiconductor manufacturing plant, and a step of manufacturing semiconductor devices with the plurality of manufacturing apparatus for semiconductor process that are installed.

Also, the semiconductor device manufacturing method of the invention further comprises a step of connecting the semiconductor manufacturing apparatus including the exposure apparatus via a local area network, a step of connecting the local area network with an external network outside the semiconductor manufacturing plant, a step of acquiring the information concerning the exposure apparatus from a database on the external network, employing the local area network and the external network, and a step of controlling the exposure apparatus on the basis of the acquired information.

Further, the semiconductor device manufacturing method of the invention further comprises acquiring the maintenance information of the manufacturing apparatus in the data communication by gaining access to a database provided by the bender or the user of the exposure apparatus via the external network, or making the production management in the data communication via the external network with another semiconductor manufacturing plant that is different from the semiconductor manufacturing plant.

A semiconductor manufacturing plant accommodating the exposure apparatus of the invention comprises a plurality of semiconductor manufacturing apparatus for process including the exposure apparatus, a local area network for connecting between the semiconductor manufacturing apparatus, and a gateway for connecting the local area network and an external network outside the semiconductor manufacturing plant, wherein the information concerning at least one of the semiconductor manufacturing apparatus can be conveyed in the data communication.

A maintenance method for the exposure apparatus according to the invention comprises a step of preparing a database storing the information concerning the maintenance of the exposure apparatus on an external network outside the plant where the exposure apparatus is installed, a step of connecting the exposure apparatus to a local area network inside the plant, and a step of performing the maintenance of the exposure apparatus on the basis of the information stored in the database, employing the external network and the local area network.

Preferably, the exposure apparatus according to the invention further comprises an interface for effecting connection with the network, a computer for executing a network software for performing the data communication of the maintenance information of the exposure apparatus via the network, and a display for displaying the maintenance information of the exposure apparatus that is communicated in accordance with the network software executed by the computer.

Further, preferably, in the exposure apparatus of the invention, the network software provides a user interface for gaining access to the maintenance database connected to the external network of the plant where the exposure apparatus is installed and provided by the vendor or the user of the exposure apparatus, on the display, making it possible to acquire the information from the database via the external network.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitutes a part of the specification, illustrate embodiments of the invention and, together with the description, serve to explain the principles of the invention.

FIG. 1 is a diagram showing an active vibration isolator incorporated into a feedback loop for damping according to a first embodiment of the invention;

FIG. 2 is a diagram showing a device configuration of an active vibration isolator for making the adjustment of damping for each vibration mode according to a second embodiment of the invention;

FIG. 3 is a diagram showing a device configuration of an active vibration isolator according to a third embodiment of the invention, which is a variation of the second embodiment;

FIG. 4 is a graph showing how to provide damping for each vibration mode employing a frequency response for the active vibration isolator according to the third embodiment of the invention;

FIGS. 5A to 5C are graphs showing how to suppress a resonance peak of an active vibration isolator according to a fourth embodiment of the invention;

FIG. 6 is a diagram showing a pseudo impulse and a time response for the active vibration isolator according to the fourth embodiment of the invention;

FIG. 7 is a diagram showing how to apply a pseudo impulse or a sweep sinusoidal wave signal to the active vibration isolator according to the fourth embodiment of the invention;

FIG. 8 is a flowchart for calculating a mode matrix based on the time response according to the fourth embodiment of the invention;

FIG. 9 is a flowchart for calculating a mode matrix φ based on the frequency response according to a fifth embodiment of the invention;

FIG. 10 is a concept view of a semiconductor device production system including an exposure apparatus according to one embodiment of the invention, as seen from a certain angle;

FIG. 11 is a concept view of a semiconductor device production system including an exposure apparatus according to one embodiment of the invention, as seen from another angle;

FIG. 12 is a view showing a specific example of a user interface in a semiconductor device production system including an exposure apparatus according to one embodiment of the invention;

FIG. 13 is a flowchart for explaining a device manufacturing process with the exposure apparatus according to one example of the invention;

FIG. 14 is a block diagram for explaining a wafer process with the exposure apparatus according to one example of the invention;

FIG. 15 is a view showing a device configuration of a hybrid active vibration isolator in the conventional example; and

FIG. 16 is a view showing a feedback configuration of the conventional active isolator applied on a table for vibration isolating of FIG. 15.

### DETAILED DESCRIPTION OF THE PREFERRED EMBODIMENTS

Preferred embodiments of the present invention will now be described in detail in accordance with the accompanying drawings.

[First Embodiment]

Before the detailed description of this embodiment, a basic concept of the present invention will be described below again. First of all, a position control loop in an active vibration isolator has a function of orienting an exposure apparatus itself at a predetermined location. Accordingly, at the time of adjustment for orientation, it is convenient that the attitude of the exposure apparatus main body is adjusted by translating the exposure apparatus main body minutely in a desired direction, or rotating it. That is, it is desired that a control loop of position is applied on the basis of the motion mode of translation and rotation. However, since a vibration control loop represented by a feedback loop of acceleration has a role of providing damping to the mechanical vibration, it is desirable that the damping is normally applied for each vibration mode rather than each motion mode. The conventional loop configuration for providing damping for each motion mode had a great merit that the attenuation of the table for vibration isolating can be more finely adjusted for each motion mode, as compared with the loop configuration independent for each axis. However, if the damping to the mechanical resonance is provided for each vibration mode, but not for each motion mode, the vibration characteristic of the table for vibration isolating can be more finely adjusted. This is because the attenuation amounts of plural mechanical resonances for the table for vibration isolating can be adjusted individually.

Thus, the invention is directed to an active vibration isolator for controlling the positioning of a main body structure having the table for vibration isolating with a plurality of air spring actuators AS (which are driven through the position control loop for each motion mode), and affording damping to the main body structure having the table for vibration isolating, employing a plurality of electromagnetic actuators such as linear motors LM (which are driven through the vibration control loop for each vibration mode), wherein it is figured out that the control loop for damping is reconfigured from the conventional loop based on the motion mode to the loop based on the vibration mode.

Conventionally, the output signals of the acceleration sensors AC-Z1, AC-Z2, AC-Z3, AC-X1, AC-Y2 and AC-Y3 are led to motion mode extracting calculator 9 to calculate an motion mode acceleration signal (aₓ, a_{y}, a_{z}, aθₓ, aθ_{y}, aθ_{z}), which is compensated individually. In this embodiment, a vibration mode acceleration signal is extracted, instead of the motion mode acceleration signal. First of all, the concept of the vibration mode that is introduced instead of the motion mode will be set forth below.

Generally, an equation of motion for a rigid body can be represented in the following manner.

M\ddot{X}+C\dot{X}+KX=F (1)

Where

M: mass matrix

C: viscous friction matrix

K: rigidity matrix

X: displacement vector

F: driving force vector (translation and rotation)

X=φΣ (2)

Employing a mode matrix φ, the equation of motion (1) is rewritten as follows.

\tilde{M}\ddot{Σ}+\tilde{C}\dot{Σ}+\tilde{K}Σ=φ^{T}F (3)

Where

\tilde{M}=φ^{T}Mφ (4a)

\tilde{C}=φ^{T}Cφ (4b)

\tilde{K}=φ^{T}Kφ (4c)

It is known that \tilde{M}, \tilde{C} and \tilde{K} are made a diagonal matrix. However, it is not assured that \tilde{C} is made the diagonal matrix in all cases.

Considering Σ in a mode coordinates system through the transformation of expression (2), the vibration modes become independent from each other. Since the vectors in a natural vibration mode are orthogonal, the orthogonal elements are only left in the matrices (4a), (4b) and (4c), and the non-orthogonal terms become zero. Accordingly, in an equation of motion that is made discrete in the expression (3), for example, the non n-order vibration mode of vibration components is not coupled with the n-order vibration mode, and the equation of motion is separately treated for each vibration mode. This idea is introduced into the feedback for damping. That is, an acceleration signal is transformed into a vibration mode acceleration signal A, employing a relational expression in which the expression (2) is differentiated up to second order, which is then damped for each vibration mode.

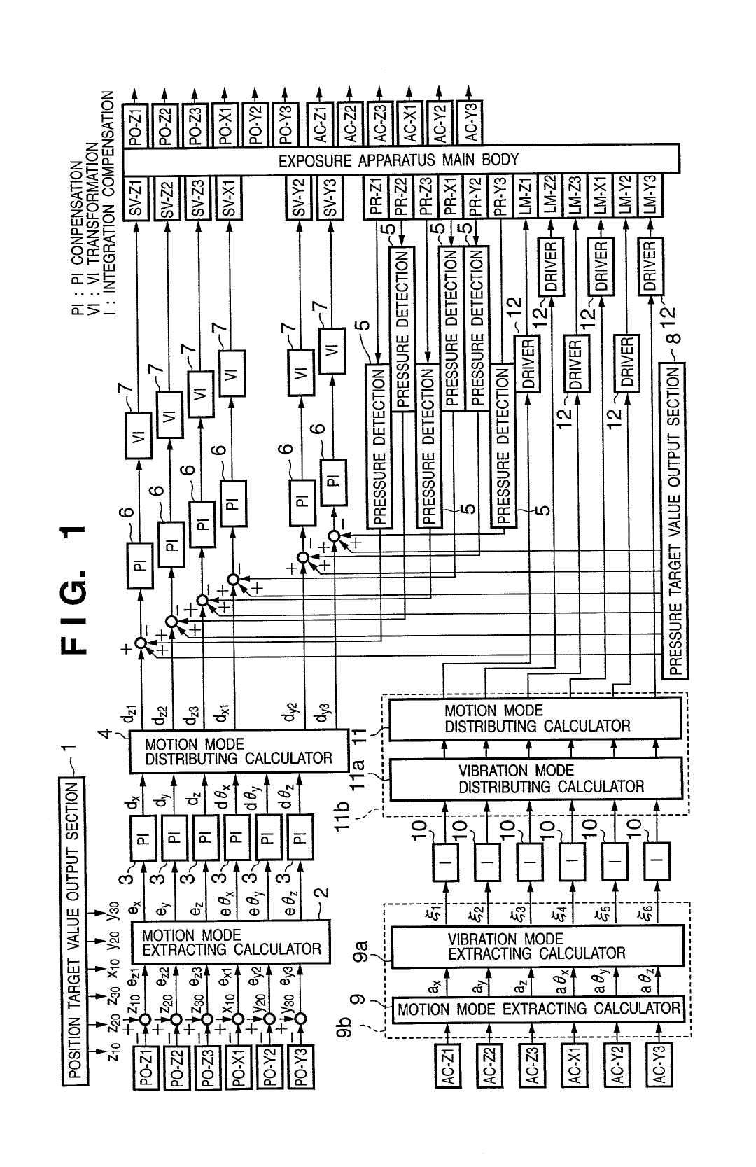

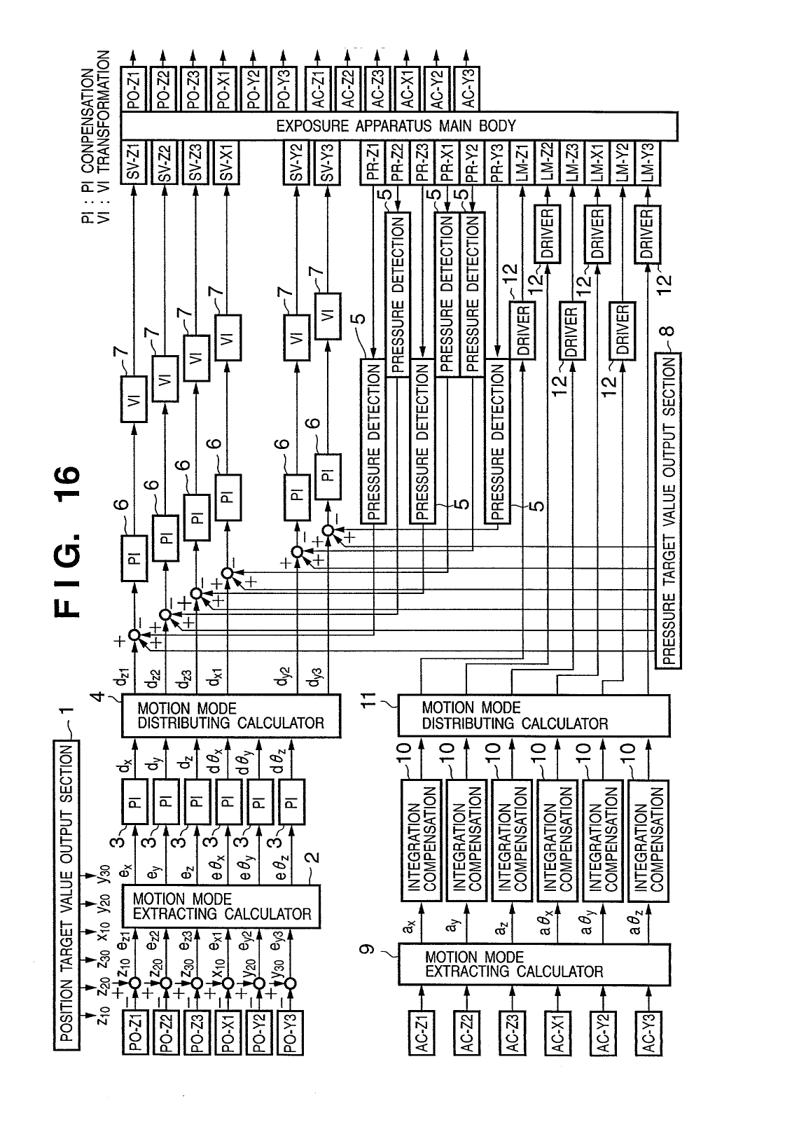

FIG. 1 shows an active vibration isolator incorporated into a feedback loop (vibration control loop) for providing damping on the basis of the above concept. Comparing FIGS. 1 and 16, the configuration of feedback loop is different in that vibration mode extracting calculator 9a is newly inserted into the next stage of the motion mode extracting calculator 9 regarding the acceleration, and vibration mode distributing calculator 11a is newly inserted into the former stage of the motion mode distributing calculator

First of all, an output of the acceleration sensor AC is input into the motion mode extracting calculator 9, this output becoming an motion mode acceleration signal (aₓ, a_{y}, a_{z}, aθₓ, aθ_{y}, aθ_{z}) , resulting in a signal corresponding to the second order differential of X as given in the left side of the expression (2). Then, to transform this signal into a vibration mode acceleration signal,

\ddot{Σ}=(\ddot{ξ}₁, \ddot{ξ}₂, \ddot{ξ}₃, \ddot{ξ}₄, \ddot{ξ}₅, \ddot{ξ}₆)^{T}

on the basis of the relational expression of second order differential of the expression (2), the motion mode acceleration signal is input into the vibration mode extracting calculator 9a. As will be clear from the transformation of the expression (2), the arithmetical operation content of the vibration mode extracting calculator 9a is φ⁻¹.

Subsequently, each output of the vibration mode extracting calculator 9a is passed through an integral compensator 10 and transformed into a speed signal for each vibration mode. The integral compensator 10 is able to perform the integral operation and increase or decrease the gain. The increase or decrease of gain in the integral compensator 10 has a role of providing independent damping for each vibration mode. That is, an output of the integral compensator 10 becomes a drive signal for producing a driving force as damping with the linear motor LM for each vibration mode. This drive signal must be distributed in consideration of the actual spatial arrangement of the linear motor LM. Therefore, an output of the integral compensator 10 is firstly input into the vibration mode distributing calculator 11a and employed as a drive signal for the motion mode as the output of the same vibration mode distributing calculator. This arithmetical operation content is φ^{-T}, as will be apparent in consideration of the relation of the right side of the expression (3). And a drive signal for producing damping for the motion mode is input into the motion mode distributing calculator 11 at the next stage, and transformed into a drive signal for each axis to produce damping in a region where the linear motor LM is disposed. This drive signal for each axis is made an input signal of a driver 12 for conducting an electric current to the linear motor LM, so that the electric current flows through the linear motor LM to produce a driving force as the damping.

In the explanation of FIG. 1, the motion mode extracting calculator 9 and the vibration mode extracting calculator 9a are implemented separately and inserted into the control loop. Similarly, the motion mode distributing calculator 11 and the vibration mode distributing calculator 11a are implemented separately and inserted into the control loop. Of course, the motion mode extracting calculator 9 and the vibration mode extracting calculator 9a may be collectively implemented as vibration mode extracting calculator 9b. Similarly, the motion mode distributing calculator 11 and the vibration mode distributing calculator 11a are implemented collective as vibration mode distributing calculator 11b.

In this embodiment as shown in FIG. 1, the acceleration sensors AC are employed as a plurality of vibration sensor. Other vibration sensors may include a velocity sensor of servo type to output a speed signal and a geophone sensor. Configuring a vibration control loop employing this velocity sensor also belongs to this embodiment. In this case, needless to say, the velocity sensor may be used instead of the acceleration sensor AC in FIG. 1, but the compensator has a different constitution. That is, the integral compensator 10 is changed to a gain compensator. The arithmetical operation contents of the motion mode extracting calculator 9, the vibration mode extracting calculator 9a, the vibration mode distributing calculator 11a and the motion mode distributing calculator 11 and the arrangement of the vibration control loop are the same as in FIG. 1.

[Second Embodiment]

In the first embodiment, in the hybrid active vibration isolator employing the air spring actuator AS and the linear motor LM representative of the electromagnetic actuator, the linear motor LM is driven to provide damping to the mechanical resonance of the support mechanism. In this case, the vibration mode of the table for vibration isolating 22 supported by the support mechanism is calculated by using an output of the acceleration sensor AC representative of the vibration sensor, and then the gain is increased or decreased by the integral compensator 10 to obtain a signal for adjusting the damping for each vibration mode, whereby the vibration mode or motion mode is distributed in consideration of the relation between the vibration mode and the motion mode and the spatial arrangement of the linear motor to produce damping on the basis of this signal. On the other hand, the air spring actuator AS is employed for the position control to orient the table for vibration isolating 22 at a predetermined position. This position control has a feature that the control system is configured for each motion mode of translation or rotation. Herein, the linear motor LM having excellent driving characteristics is employed to produce a driving force for damping, but the air spring actuator AS may be employed to produce damping.

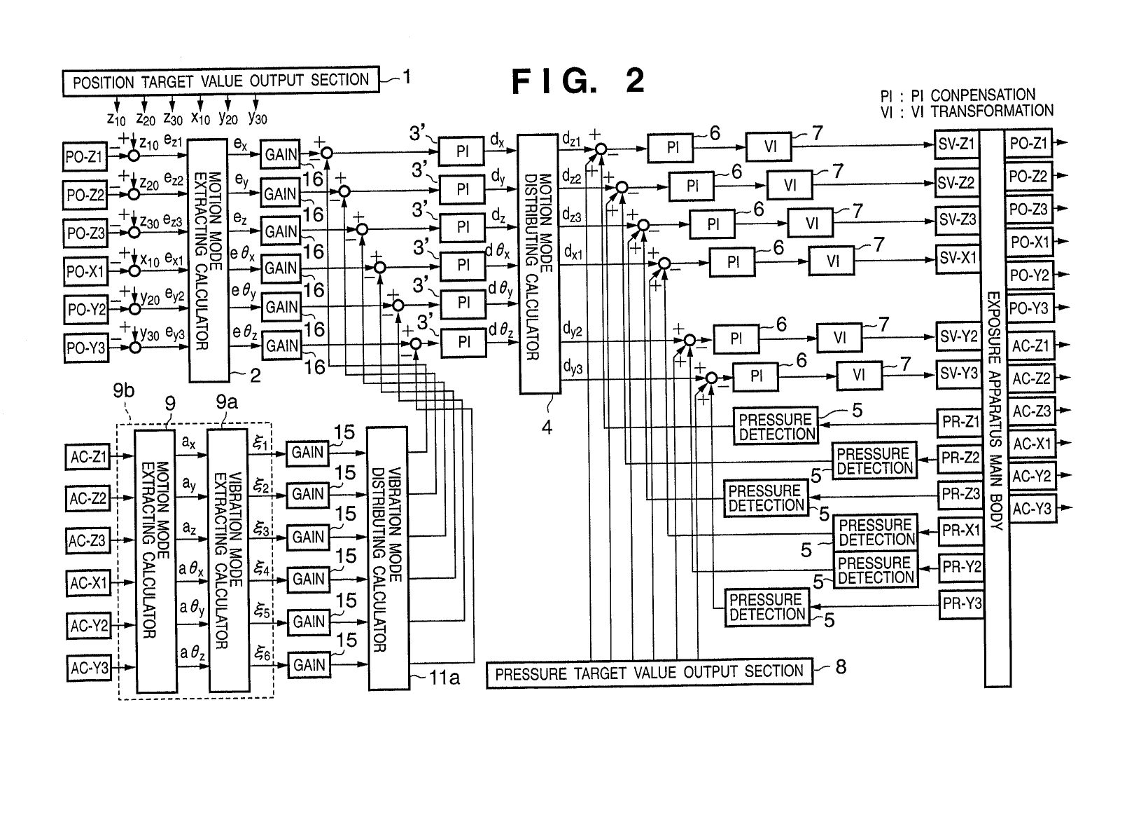

Thus, FIG. 2 shows a loop configuration in which the air spring actuator AS has the table for vibration isolating 22 oriented at a predetermined position, and is employed to produce damping, or a device configuration in which the damping is adjusted for each vibration mode instead of the conventional motion mode. In FIG. 2, the same or like parts designated with the same numerals as in FIG. 1 and already described are not described duplicately.

In FIG. 2, the vibration control loop is a different portion from FIG. 1. In FIG. 2, an output of the acceleration sensor AC is firstly led into the motion mode extracting calculator 9 to calculate an motion mode acceleration signal (aₓ, a_{y}, a_{z}, aθₓ, aθ_{y}, aθ_{z}). Subsequently, employing a relation of second order differential of the expression (2), the motion mode acceleration signal is input into the vibration mode extracting calculator 9a to calculate a vibration mode acceleration signal

(\ddot{ξ}₁, \ddot{ξ}₂, \ddot{ξ}₃, \ddot{ξ}₄, \ddot{ξ}₅, \ddot{ξ}₆)

The vibration mode acceleration signal is led to a gain compensator 15. By adjusting the gain of the gain compensator 15, the damping for each vibration mode can be increased or decreased. Then, an output of the gain compensator 15 is led to the vibration mode distributing calculator 11a to produce a driving force command of the motion mode in an actual physical coordinate system on the basis of the relation of the right side of the expression (3). And an output of the vibration mode distributing calculator 11a is fed back to the former stage of a PI compensator 3′ regarding the acceleration disposed at the former stage of the motion mode distributing calculator 4. The role of the PI compensator 3′ regarding the acceleration is to set off the pole of the first order lag for the pressure feedback loop against zero point of the PI compensator 3′ regarding the acceleration by arranging the PI compensator 3′ regarding the acceleration at this former stage, because the pressure feedback loop has a first order lag as described in JP-A-11-327657 (active vibration isolator and exposure apparatus). And the damping is provided using a complete integral characteristic of the PI compensator 3′. That is, if an acceleration signal is applied to the former stage of the PI compensator 3′ regarding the acceleration, its output is a speed signal, and acts to produce a driving force as damping. A gain compensator 16 regarding the position arranged at the former stage of the PI compensator 3′ regarding the acceleration compensates a gain for the output of an motion mode deviation signal (eₓ, e_{y}, e_{z}, eθₓ, eθ_{y}, eθ_{z}) to adjust the positional attitude of the table for vibration isolating 22 for each motion mode. Based on such a principle, reference is made to FIG. 2 again.

A signal at the input stage of the vibration mode distributing calculator 11a is a manipulated variable to produce damping for each vibration mode. This signal is enabled to produce damping as the motion mode via the vibration mode distributing calculator 11a. If this signal is fed back to the former stage of the PI compensator 3′ regarding the acceleration, it becomes a signal corresponding to speed with the integral characteristic of the PI compensator 3′, the signal producing a driving force as damping.

In a case of FIG. 2, like FIG. 1, the motion mode extracting calculator 9 and the vibration mode extracting calculator 9a are collectively implemented as vibration mode extracting calculator 9b.

[Third Embodiment]

In the second embodiment, the air spring actuator AS is employed to produce a driving force as damping and a driving force for the positional control for orientation at a predetermined position. In this case, a pressure feedback is introduced of detecting a pressure within the air spring actuator AS and feeding back its detected output. This is a pressure feedback in a welding pressure feedback as disclosed in JP-A-10-256141 (active vibration isolator) and JP-A-11-44337 (active vibration isolator of air spring type). However, to additionally provide the pressure feedback, a pressure gauge is required to install, clearly increasing the cost. In a simple active vibration isolator not required to manage the driving force of the air spring actuator AS at high precision, it is not requisite to incorporate the pressure feedback. Thus, in a third embodiment, an active vibration isolator capable of adjusting the damping for each vibration mode is configured when the pressure feedback is not incorporated.

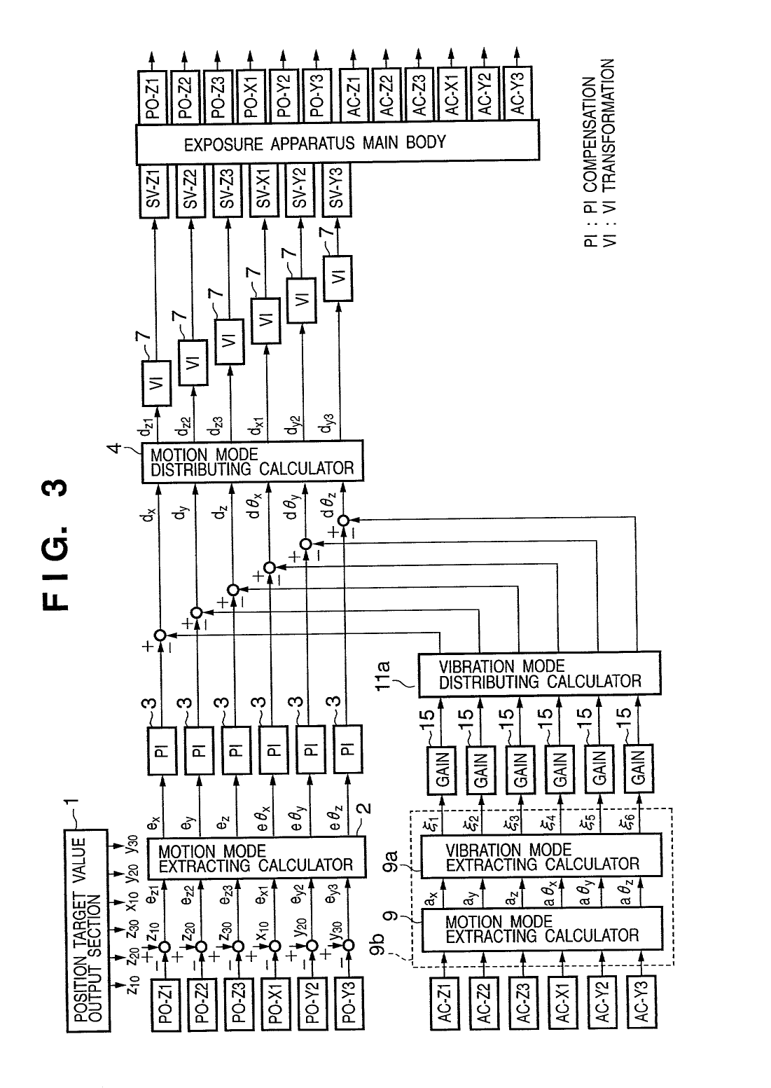

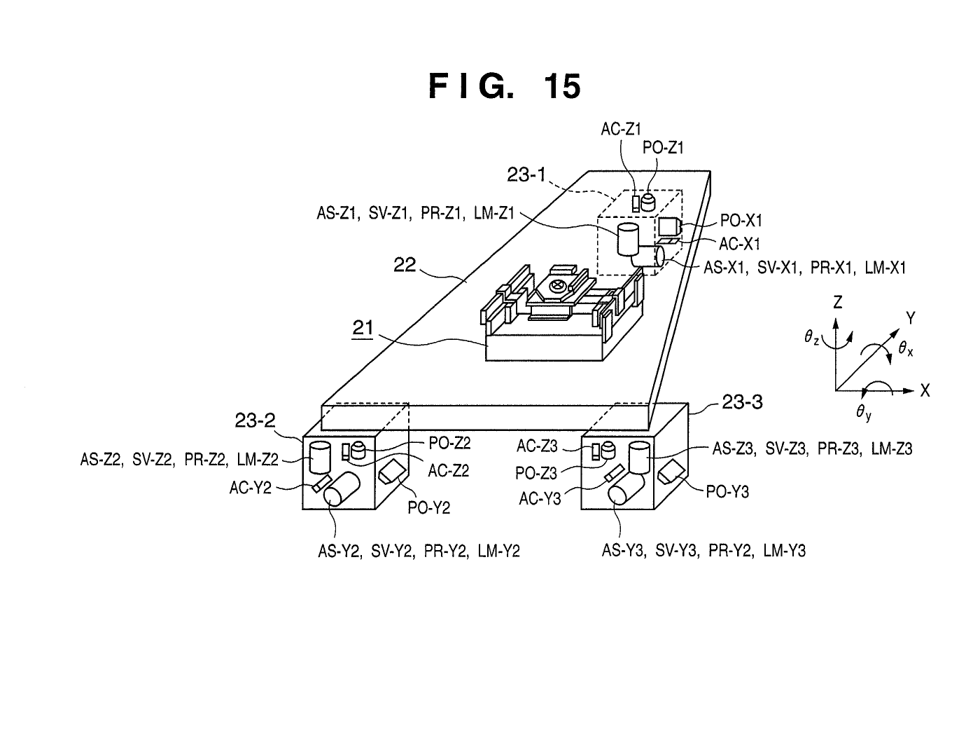

FIG. 3 shows the configuration of an active vibration isolator according to a third embodiment of the invention, as a variation of the second embodiment. Reference is made to FIGS. 3 and 15. Herein, it is employed that the frequency characteristic from an input voltage into a voltage-current transducer 7 for controlling the opening or closing of a servo valve SV for adjusting the internal pressure of the air spring actuator AS to the internal pressure of the air spring actuator AS is approximately the integral characteristic. That is, if the vibration of the table for vibration isolating 22 is detected by the acceleration sensor Ac, multiplied by an appropriate gain, and fed back to the former stage of the voltage-current transducer 7, the damping is given to the table for vibration isolating 22 due to this integral characteristic. This operation is practiced for each vibration mode, and an output of the acceleration sensor AC is led to the motion mode extracting calculator 9 to produce an motion mode acceleration signal (aₓ, a_{y}, a_{z}, aθₓ, aθ_{y}, aθ_{z}), as shown in FIG. 3. Then, to transform this signal into a vibration mode acceleration signal,

Σ=(\ddot{ξ}₁, \ddot{ξ}₂, \ddot{ξ}₃, \ddot{ξ}₄, \ddot{ξ}₅, \ddot{ξ}₆)^{T}

on the basis of the relational expression of second order differential of the expression (2), the motion mode acceleration signal is input into the vibration mode extracting calculator 9a. An output of the vibration mode extracting calculator 9a is a vibration mode acceleration signal, which is led to a gain compensator 15 for adjusting the gain for each vibration mode to produce a drive signal to produce damping for each vibration mode. This drive signal, which is for the vibration mode, is led to the vibration mode distributing calculator 11a to make the drive signal for the motion mode on the basis of the relational expression of the right side of the expression (1), thereby producing a driving force in an actual physical coordinate system. This output, which is a drive signal to produce damping for each motion mode, is fed back to the former stage of the motion mode distributing calculator 4 through which a feedback signal of the motion mode regarding the position flows, and which is a section in the motion mode of the same kind. Thus, it is added to a feedback signal in the motion mode regarding the position to make an motion mode drive signal (dₓ, d_{y}, d_{z}, dθₓ, dθ_{y}, dθ_{z}). This motion mode drive signal generates a drive signal (d_{z1}, d_{z2}, d_{z3}, dₓ₁, d_{y2}) for each axis to be produced in an actual region where the air spring actuator AS is arranged by passing through the motion mode distributing calculator 4 in consideration of the geometrical arrangement of the air spring actuator AS regarding the center of gravity for the table for vibration isolating 22. The drive signal for each axis contains, as a signal component, the vibration mode acceleration signal

(\ddot{ξ}₁, \ddot{ξ}₂, \ddot{ξ}₃, \ddot{ξ}₄, \ddot{ξ}₅, \ddot{ξ}₆)

which has passed through the gain compensator 15 and is conveyed via the vibration mode distributing calculator 11a and the motion mode distributing calculator 4. This signal component produces a driving force to act as damping to the table for vibration isolating 22, because the characteristic from the input into the voltage-current transducer 7 to the pressure of the air spring actuator AS is approximately the integral characteristic. Of course, since there is a drift from the integral characteristic in a frequency region out of the integral characteristic, namely, in the low frequency region and the high frequency region, the damping does not occur in these frequency regions.

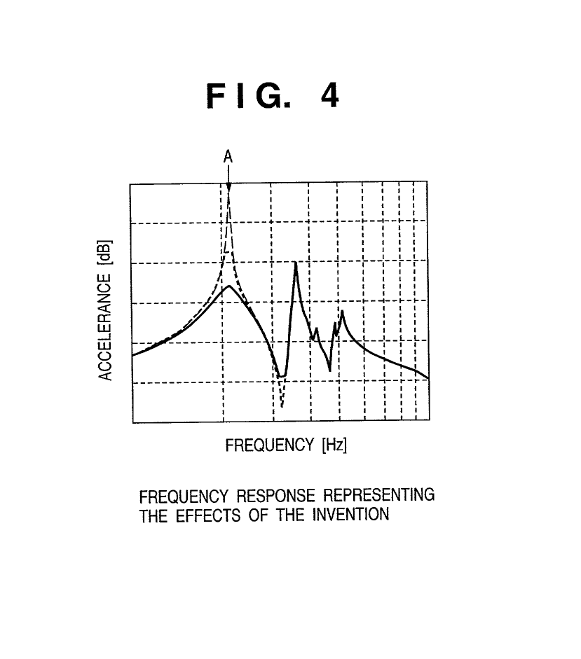

Lastly, FIG. 4 shows a way of damping for each vibration mode using the frequency response. In other words, FIG. 4 shows the frequency characteristic from the force in the motion mode applied to the table for vibration isolating to the acceleration in the motion mode, namely, accelerance. In the same figure, five resonance peaks can be clearly recognized. In order to attenuate the vibration mode having the lowest frequency as indicated by A, the gain for damping to the vibration mode is adjusted (in other words, the gain of the integral compensator 10 is manipulated in FIG. 1). Attenuating the vibration mode from a curve of the dotted line in less attenuated state, a curve of the broken line results, and further increasing the gain, the resonance peak can be eliminated as indicated by the solid line. In the adjustment of damping to the vibration mode, the vibration modes other than the vibration mode A are not attenuated at all. The vibration mode of notice can be only attenuated.

However, in case of the conventional loop configuration of damping for each motion mode, or when the adjustment of damping to the motion mode is made, almost all the resonance peaks appearing in FIG. 4 are lowered. Accordingly, as the adjustment for each motion mode is made, the resonance peaks are increasingly attenuated, or a so-called over-damping is caused. As well known, the over-damping state makes the positioning convergence slow. To get rid of the over-damping state, after completion of one adjustment for the motion mode, the gain adjustment for the motion mode regarding the acceleration already adjusted must be practiced again. However, in the loop configuration for each vibration mode, the damping can be given independently for each vibration mode, whereby there is no problem in principle of over-damping. Accordingly, one adjustment is sufficient for each vibration mode in sequence.

[Fourth Embodiment]

In the first to third embodiments (see FIGS. 1, 2, 3 and 15) as described above, it is required to provide damping to suppress the resonance peak of each vibration to settle the positioning attitude of the table for vibration isolating. In this case, it is preferred that the resonance peaks are suppressed individually. This is because the stabilization of the table for vibration isolating depends on the amount of suppressing the resonance peak. However, it is not true that a greater suppression of the resonance peak is favorable. If the suppression is too strong, the movement of the table for vibration isolating 22 is slower in a so-called over-damping state. The amount of suppressing the resonance peak is deeply involved in the stabilization for positioning.

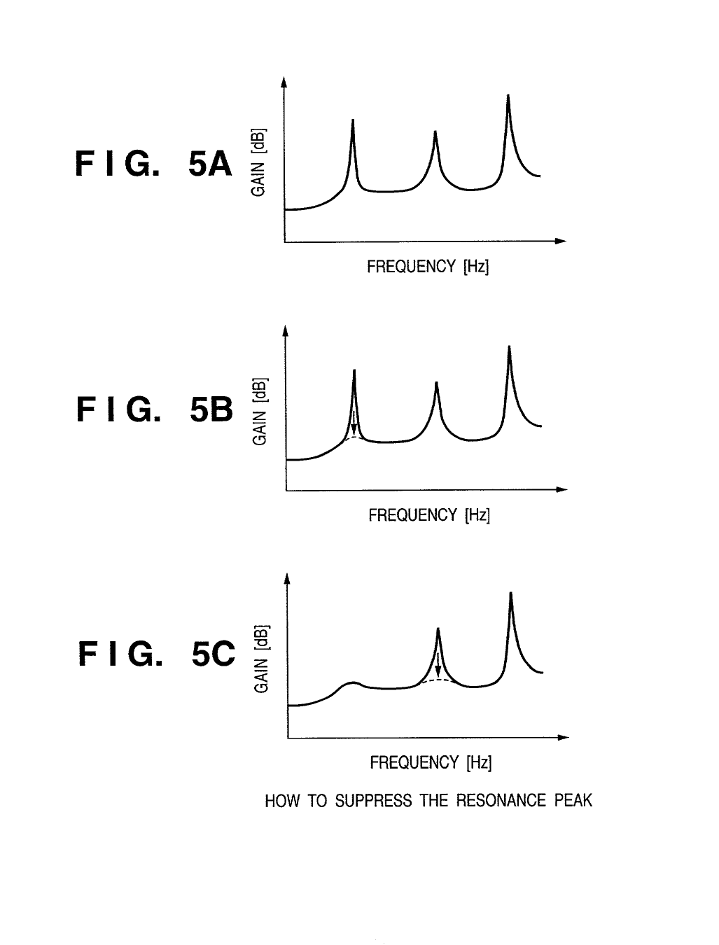

And a difference in the control structure between the motion mode and the vibration mode gives rise to a definite variation in a way of suppressing the resonance peak. This variation will be described below in connection with FIGS. 5A to 5C in which there appear three kinds of resonance peaks in vibration. FIG. 5A shows the frequency characteristic from the force to the acceleration, for example, when no damping is applied. Herein, there are three sharp resonance peaks. In a non-interacting control system for each vibration mode, the damping is applied in the following manner.

First of all, damping is applied to a resonance peak with the lowest frequency among the resonance peaks. Thus, the resonance peak is suppressed as indicated by the broken line in FIG. 5B. However, no damping is applied to the second and third resonance peaks. Then, the damping is applied to the second resonance peak as shown in FIG. 5C. The damping can be applied only to the second resonance peak without having influence on the first resonance peak already damped and the third resonance peak. This way of damping allows for the independent adjustment for each vibration mode, and is preferable for the stabilization in positioning the table for vibration isolating.

Referring to FIGS. 5A to 5C, the state of adjustment in the non-interacting control system for each motion mode will be described below. By making the adjustment to provide damping to the first resonance peak, the first resonance peak is exclusively damped. However, slight damping may be applied to the second and third resonance peaks. Then, the adjustment is made to provide damping to the second resonance peak. At this time, the second resonance peak is predominantly damped, but the damping may be applied to the first resonance peak already adjusted. Not to be careful, the over-damping may be applied to the first resonance peak, bringing about the danger that the positioning is slower.

The above difference in the adjustment of damping is caused by the feedback structure of whether the vibration control loop is vibration mode or motion mode. Of course, the vibration mode control system is more excellent in the adjustment of damping, and therefore has a high ability for improving the stabilization of positioning.

By the way, conventionally, the motion mode extracting calculator 2 and the motion mode distributing calculator 4 were determined by the geometrical arrangement of the position sensor PO and the air spring actuator AS, respectively. Accordingly, if the center of gravity of the table for vibration isolating is known, and the coordinates for arranging the position sensor PO and the air spring actuator AS are found, they can be easily implemented. Since the geometrical information is easily found with reference to the machine drawings, if completely furnished, there are no technical difficulties in implementing the non-interacting control system for each motion mode.

On the other hand, the non-interacting control system for each vibration mode allows the adjustment of damping for each vibration mode, thus making the stabilization of positioning the table for vibration isolating 22 excellently. However, the vibration mode extracting calculator 9a and the vibration mode distributing calculator 11a in the non-interacting control system for each vibration mode were obtained as a result of the mode analysis, without relying on the geometrical arrangement. Accordingly, there was some difficulty in implementing them, in contrast to the non-interacting control system for each motion mode. This is because theoretically, the mode matrix φ is calculated from the mass matrix M and the rigidity matrix K, which must be obtained as the numerical values. An operation of calculating the mass matrix M and the rigidity matrix K before the active vibration isolator is troublesome and complicated. The identification for calculating M and K does not directly improve the performance of the device, and is avoided, and it takes a lot of time to make the measurement. Moreover, it is well known that the operation of the non-interacting control system for each vibration mode configured employing the mode matrix φ calculated from M and K as obtained is not excellent, because the reliability of M and K values is lower.

In other words, the non-interacting control system for each vibration mode is a structure of the control system capable of adjusting the stabilization of positioning the table for vibration isolating more finely than the non-interacting control system for each motion mode, and can implement the vibration isolating and control performance quite more excellent than the feedback independent for each axis. However, regrettably, there was the problem that, in implementing the non-interacting control system for each vibration mode, there was no method for calculating the mode matrix φ simply, in a short time, and at high precision.

When the non-interacting control system for each vibration mode as described in the first to third embodiments is implemented in the active vibration isolator, a key for operating the system according to the purpose resides in the calculation of the mode matrix. If the calculation precision is poor, the adjustment is only made as finely as in the non-interacting control system for each motion mode as described in the paragraph “Prior Art”. That is, though the resonance peak of notice is principally suppressed by damping adjustment, the adjacent peaks may be affected.

A feature of the non-interacting control system for each vibration mode is the capability of damping adjustment to suppress the resonance peaks independently of each other. If this feature is impaired, it is not necessary to change the design from the non-interacting control system for each motion mode to the non-interacting control system for each vibration mode.

That is, a key for enjoying the feature of the non-interacting control system for each vibration mode resides in the calculation of the mode matrix φ at high precision. In addition, since the exposure apparatus having the active vibration isolator incorporated is the industrial production apparatus, it is desired that the calculation of the mode matrix φ is performed simply and in short time.

Conventionally, the inertia matrix M and the rigidity matrix K were calculated by vibrating the table for vibration isolating, and the mode matrix φ was obtained (see the expression (3) in the first embodiment). However, the operation of obtaining the mode matrix φ after calculating M and K was troublesome, and the precision of the value of mode matrix φ was controversial in configuring the vibration mode control system.

Thus, in this embodiment, it is figured out that the mode matrix φ is calculated on the basis of the measured data employing an actual machine without calculating M and K, and employed for the non-interacting control system for each vibration mode.

First of all, a calculation procedure of the mode matrix φ on the basis of the time response will be set forth below. A Prony method is well known as the method based on the time response data. This method involves determining the vibration mode from a time response waveform of a positioning object to an impulse input. However, the impulse is an ideal waveform having an infinite amplitude at a time width of zero, and it is impossible to input this waveform into the actual machine. Accordingly, in this embodiment, a pseudo impulse having a finite time width and an amplitude is input into the actuator. Herein, for an input method, it is required that all the resonance peaks for the mechanical system can be excited by driving with the pseudo impulse to effect the measurement in short time and achieve the high precision.

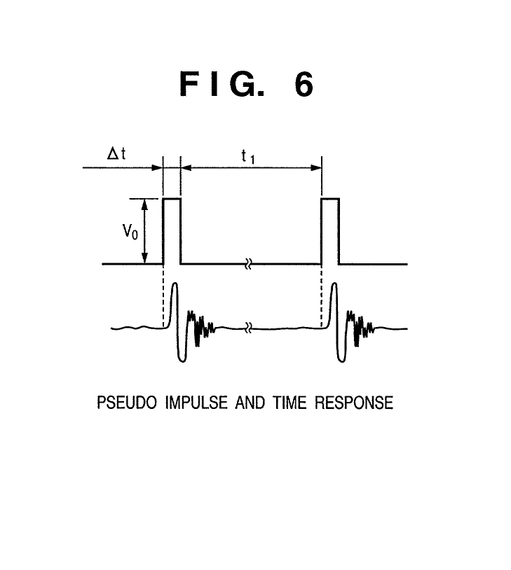

Of course, a response to an input of pseudo impulse converges after the elapse of time if the mechanical system is stable. Hence, after the elapse of time, i.e., after the response converges fully, a pseudo impulse is input again to capture the time response waveform. Thereby, through the statistical processing of the time response waveform, the precision of the mode matrix φ that is acquired from the time response can be enhanced. This behavior is shown in FIG. 6. The pseudo impulse is an isolated pulse with the crest value V₀ and the time width Δt. First of all, when a first pseudo impulse is input as indicated at the upper stage, a portion of the table for vibration isolating responds as indicated at the lower stage. This response waveform converges after the elapse of time. After it has converged fully, a pseudo impulse is input again to produce a response, and acquire a second response waveform to the same pseudo impulse, whereby the statistical reliability of the response data can be enhanced. Of course, it is needless to say that the number of inputting the pseudo impulse is not limited to two, but may be three or more, and the reliability can be further enhanced. In FIG. 6, the time interval between the pseudo impulse and the next pseudo impulse is tl. This time interval is taken for the response waveform to converge fully, as described previously.

By the way, a frequency spectrum P as shown in FIG. 6 which a rectangular pseudo impulse has does not have energy over all the frequency bands. The shape of P is such that there is a main lobe having the maximum amplitude at the center of the frequency zero, and several side lobes having smaller amplitudes appear repetitively with increasing frequency. That is, specific frequencies with a spectrum of zero appear repetitively. As Δt is smaller, vibration can be applied over the wider band. On the contrary, as Δt is larger, the frequency band for effecting vibration is narrower. It is noted here that Δt must be selected such that all the vibration modes may be contained in a frequency range with the main lobe where the spectral amplitude is not attenuated. In other words, the time width Δt of pseudo impulse is selected to produce such a spectrum that all the vibration modes for the table for vibration isolating are excited with almost equal excitation force.

An input portion of pseudo impulse and its method will be described below.

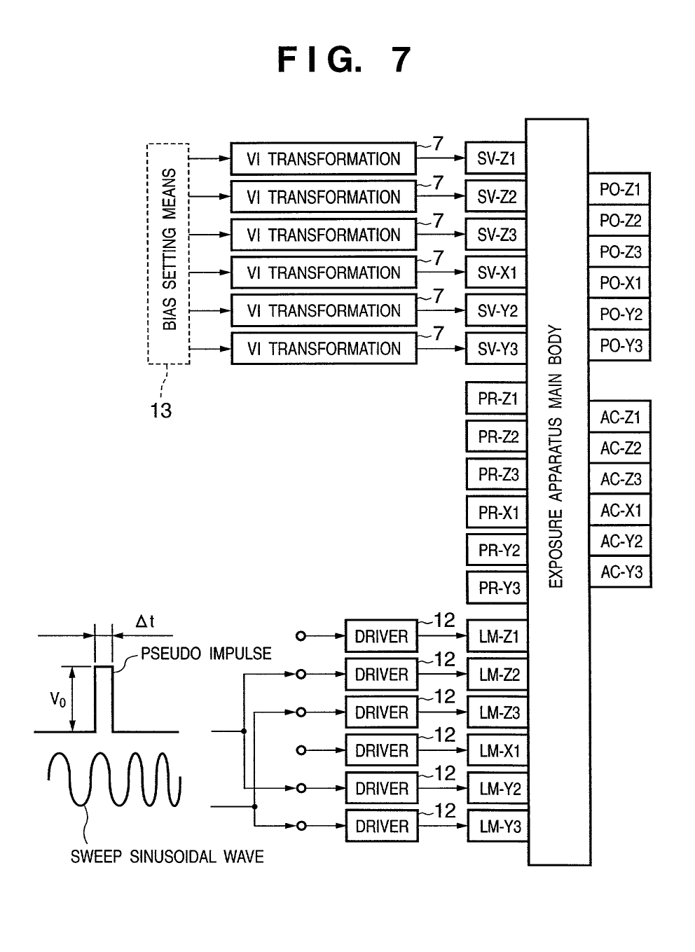

First of all, the table for vibration isolating 22 is floated near an equilibrium position. Accordingly, a voltage required to float the table for vibration isolating 22 is applied to the input of the voltage-current (VI) transducer 7 from bias setting means 13, as seen in FIG. 7. Herein, in order to acquire the support characteristic of the table for vibration isolating 22, excluding the operation of a closed loop system, the air spring actuator AS and the linear motor LM are measured in an open loop state. That is, it is a requirement in principle that the position control employing the air spring actuator AS on the basis of an output of the position sensor PO, and the vibration control employing the linear motor LM are not practiced.

However, in the case where the damping is not given, the table for vibration isolating 22 may not be oriented stably near the equilibrium position in some cases. In such cases, (1) the weak position control is provided, or (2) the weak damping is provided in addition to the position control, employing the air spring actuator AS.

In this way, a pseudo impulse simulating an impulse input is input into the linear motor LM, so that the characteristic as the open loop of the table for vibration isolating supported by the air spring actuator AS may be preserved as much as possible. By acquiring the time response waveform of the table for vibration isolating 22 at this time, the mode matrix φ is calculated.

Herein, regarding the drive shaft for inputting the pseudo impulse, for example, the simultaneous driving of LM-Z2 and LM-Z3 or the simultaneous driving of LM-Z3 and LM-Y3 is suitable, as shown in FIG. 7. Besides the above driving, the driving of the linear motor LM in one active support leg 23 may cause excitation of the table for vibration isolating 22 in the oblique direction with respect to the XYZ orthogonal axes, resulting in a displacement in all the motion modes, and this orientation of excitation is suitable.

From this point of view, LM-Z1, for example, should not be selected as the driving shaft. This is due to the fact that when the ideal driving is performed, no rotational displacement around the Y axis arises by this driving, and therefore the vibration mode is not excited.

For example, in the case where a pseudo impulse is input with LM-Z2 and LM-Y2 as the driving shaft simultaneously, the output waveforms of all the acceleration sensors AC-Z1, AC-Z2, AC-Z3, AC-X1, AC-Y2 and AC-Y3 are acquired as the data. That is, six time response waveforms for AC-Z1, AC-Z2, AC-Z3, AC-X1, AC-Y2 and AC-Y3 are acquired from the simultaneous input of pseudo impulse (the time response waveform of the table for vibration isolating to the input of pseudo impulse is measured by vibration sensor or position sensor).

Then, the (frequency) analysis for the six time response waveforms is made. Specifically, by making the frequency analysis, in which time response waveform and to what extent the vibration mode is contained, and what relation the phase of each vibration mode has, are investigated to know the elements of the mode matrix φ (i.e., the mode matrix of the table for vibration isolating can be calculated from the frequency analysis).

In calculating the mode matrix φ based on the time response as described above, the response of the table for vibration isolating 22 itself is employed. And it takes less time to make measurement. Accordingly, the mode matrix φ can be calculated at high precision, reflecting the characteristics of the actual machine, by calculating the mode matrix φ based on the analysis of time response waveform for the actual machine. And the operation of the non-interacting control system for each vibration mode can be secured, employing the mode matrix φ.

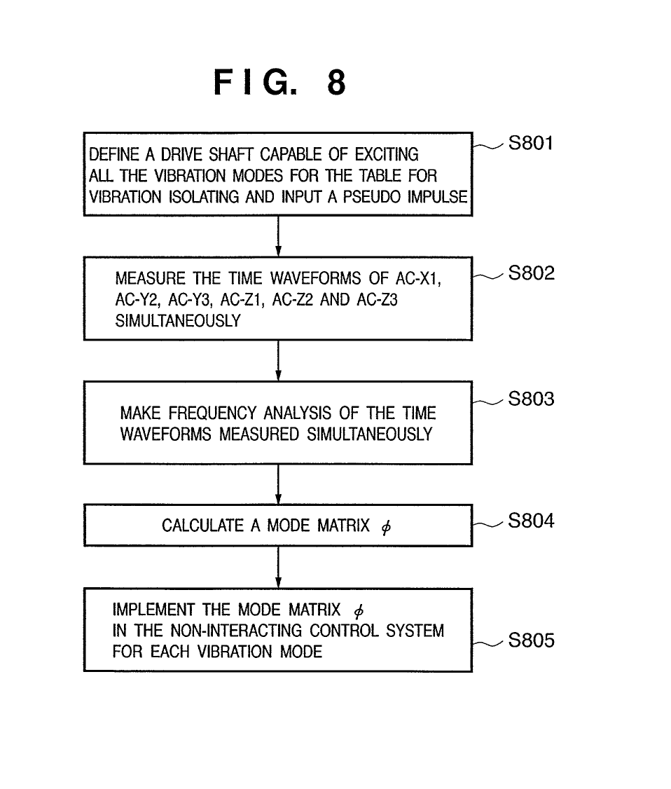

In summary, FIG. 8 shows a calculation flowchart for calculating the mode matrix φ based on the time response. At step S801, an excitation shaft of pseudo impulse is selected. It is desirable to select the portion and orientation capable of exciting all the vibration modes for the table for vibration isolating. The excitation shaft capable of exciting all the vibration modes depends on the number of active support legs supporting the table for vibration isolating, the arrangement and the center of gravity for the table for vibration isolating. Accordingly, it is not possible to effect generalization for all the active vibration isolators. However, in the case where the table for vibration isolating is supported by at least three active support legs 23, with the center of gravity at the substantial center of the table for vibration isolating 22, the simultaneous driving of the linear motors LM-Z2 and LM-Y2 within the active support leg 23-2 or the simultaneous driving of the linear motors LM-Z3 and LM-Y3 within the active support leg 23-3 is desirable. At step S802, the time waveforms of all the acceleration sensors AC to the input of pseudo impulse are measured at the same time. At step S803, the frequency analysis for the time waveforms measured simultaneously is made. At step S804, the mode matrix φ is calculated from the result of frequency analysis. At step S805, employing the mode matrix φ calculated, the vibration mode extracting calculator 9a and the vibration mode distributing calculator 11a that are the components in the non-interacting control system for each vibration mode are implemented.

In some cases, the support characteristic of the table for vibration isolating may has a dispersion for each machine. From the aspect of rapid device production, it is desired to incorporate one sort of mode matrix φ into the non-interacting control system for each vibration mode. That is, from the aspect of the production, maintenance, and management of device, it is not preferable to employ the mode matrix φ with different values for each device. However, in the case where it is not possible to avoid the occurrence of dispersion in the device, it is obliged to employ the mode matrix φ with different values for each device. At this time, if the mode matrix φ can be calculated rapidly and at high precision for each device, at least the stable production of device is not impaired. At this point, the calculation of the mode matrix φ based on the time response is superior.

[Fifth Embodiment]

Instead of acquiring the time response waveform, the frequency response may be acquired to calculate the mode matrix φ. It takes some time to make measurement, as compared with the time response, but the measurement can be made at higher precision.

By the way, like the calculation of the mode matrix φ based on the time response, it is required that all the vibration modes are excited for a drive signal of sweeping sinusoidal wave. When such excitation is made, the frequency response up to a vibration sensor contained in each active support leg 23 can be acquired. In FIG. 1, the responses for the acceleration sensors AC-Z1, AC-Z2, AC-Z3, AC-X1, AC-Y2 and AC-Y3 can be acquired. Namely, at least six frequency responses can be acquired. And the data of the frequency responses are transformed into the Nyquist diagram. On the Nyquist diagram, a circle corresponding to each vibration mode is drawn. The number of circles correspond to at least the number of vibration modes. And if a curve fitting with one degree of freedom is performed to each circle, the numerical value of each element in the mode matrix φ can be calculated.

Each element of the mode matrix φ can be determined by performing such calculation for all the frequency responses.

The mode matrix φ obtained is employed to implement the vibration mode extracting calculator 9a and the vibration mode distributing calculator 11a in constructing the non-interacting control system for each vibration mode.

Herein, to identify the mode matrix φ at high precision, it is required to excite all the vibration modes for the table for vibration isolating supported by the active support leg 23. It is clear that the mode matrix φ can not be calculated from the frequency responses obtained by excitation to cause no or insufficient vibration. The mode matrix φ can be calculated only if all the vibration modes of concern can be excited.

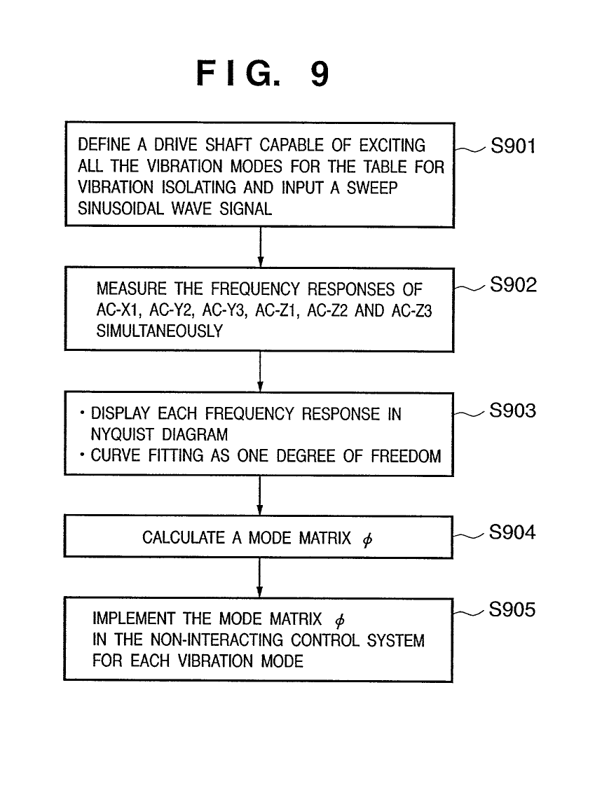

The excitation shaft capable of exciting all the vibration modes depends on the number of active support legs supporting the table for vibration isolating, the arrangement and the center of gravity for the table for vibration isolating. Accordingly, it is not possible to effect generalization for all the active vibration isolators. However, in the case where the table for vibration isolating is supported by at least three active support legs 23, with the center of gravity at the substantial center of the table for vibration isolating 22, the simultaneous driving of the linear motors LM-Z2 and LM-Y2 within the active support leg 23-2 or the simultaneous driving of the linear motors LM-Z3 and LM-Y3 within the active support leg 23-3 is desirable. FIG. 9 shows a flowchart for calculating the mode matrix φ based on the frequency response.

At step S901, like step S801 of FIG. 8, the shaft for driving the table for vibration isolating is selected by inputting a sweep sinusoidal wave signal into the actuator. It is desirable to select the portion and orientation capable of exciting all the vibration modes for the table for vibration isolating. At step S902, the frequency responses up to all the acceleration sensors AC are measured simultaneously from the sweep sinusoidal wave signal applied to the drive shaft. At step S903, the measured frequency responses are transformed into the Nyquist diagram. For each Nyquist diagram, a number of circles, large or small, are drawn corresponding to at least the number of vibration modes. A curve fitting with one degree of freedom is performed to each circle. At step S904, the numerical value of each element in the mode matrix φ can be calculated from this curve fitting. At step S905, the mode matrix φ obtained is employed to implement the vibration mode extracting calculator 9a and the vibration mode distributing calculator 11a in the non-interacting control system for each vibration mode.

In calculating the mode matrix φ, whether the method is based on the time response or the frequency response, the responses up to the acceleration sensors AC are acquired. However, whether the time response or the frequency response, the response is not limited to the output of the acceleration sensors AC. The mode matrix φ may be calculated by acquiring the time response or the frequency response up to the position sensor PO.

Also, it is not limitative that the position sensor and the vibration sensor are accommodated within the active support leg 23, but the position sensor and the vibration sensor may be installed on the table for vibration isolating to acquire the responses and calculate the mode matrix φ.

Further, in this embodiment, regarding the table for vibration isolating supported by the air spring actuator, the method for calculating the mode matrix φ and the non-interacting control system for each vibration mode employing the mode matrix φ have been demonstrated. Of course, the application of this embodiment is not limited to the active vibration isolator. The mode matrix φ is needed to suppress the vibration in the building structure, bridge or positioning mechanism, and it is needless to say that this embodiment is applicable to this calculation.

In the first to fifth embodiments as described above, it is possible to have the active vibration isolator (method for calculating the mode matrix) suitably as the vibration isolator in the exposure apparatus, and manufacture the devices such as semiconductor.

[Embodiment of Semiconductor Production System]

A production system for the semiconductor devices (semiconductor chips such as IC or LSI, liquid crystal panel, CCD, thin film magnetic head, and micromachine) employing the exposure apparatus will be described below by way of example. This makes the trouble shooting or periodical maintenance of the manufacturing apparatus installed in the semiconductor manufacturing plant or the maintenance service for providing the software through the computer network outside the manufacturing plant.

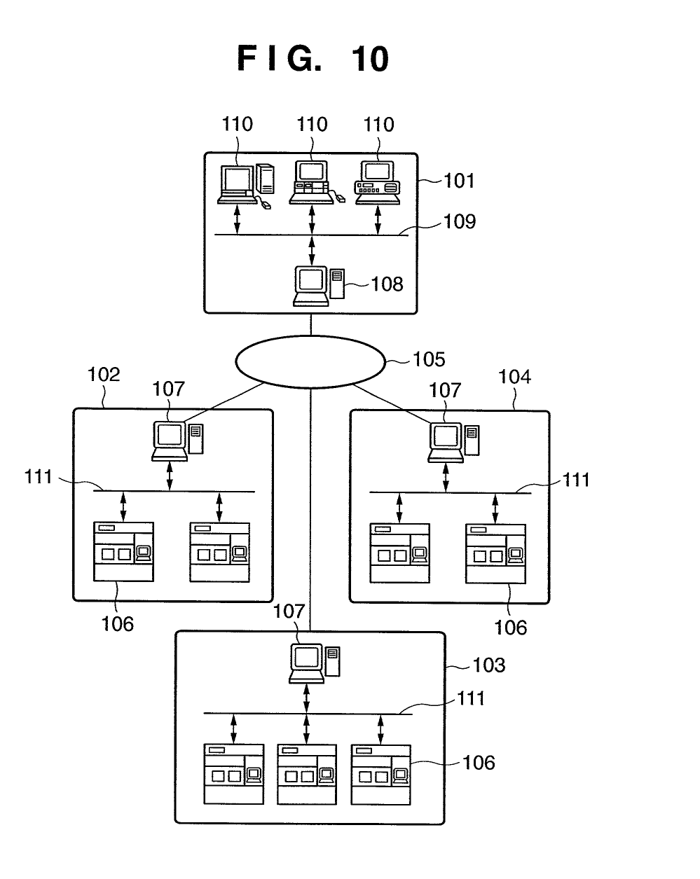

FIG. 10 shows an overall system as seen from a certain angle. In FIG. 10, reference numeral 101 denotes a business office of a vendor (apparatus supplier) for providing the semiconductor device manufacturing apparatus. The examples of the manufacturing apparatus include the semiconductor manufacturing apparatus for various processes employed in the semiconductor manufacturing plant, for example, the preprocess apparatus (an exposure apparatus, a photo-lithography processor such as a resist treating apparatus or an etching apparatus, a thermal treatment apparatus, a film formation apparatus, a flattening apparatus) and the postprocess apparatus (an assembling apparatus or a test device). Within the business office 101, there are a host management system 108 for providing a maintenance database of the manufacturing apparatus, a plurality of operation terminal computers 110, and a local area network (LAN) 109 for constructing the Intranet by connecting them. The host management system 108 has a gateway for connecting the LAN 109 to the Internet 105 that is an external network of the business office, and a security function for restricting the access from the outside.

On one hand, reference numerals 102 to 104 denote the manufacturing plant of the semiconductor manufacturing maker as the user of the manufacturing apparatus. The manufacturing plants 102 to 104 may belong to different makers, or the same maker (e.g., preprocess plant or postprocess plant). Within each manufacturing plant 102 to 104, there are provided plural manufacturing apparatus 106, a local area network (LAN) 111 for constructing the Intranet by connecting them, and a host management system 107 as a monitor for supervising the operating condition of each manufacturing apparatus 106. The host management system 107 provided in each manufacturing plant 102 to 104 has a gateway for connecting the LAN 111 within each manufacturing plant to the Internet 105 that is an external network of the plant. Thereby, access is enabled from the LAN 111 of each plant via the Internet 105 to the host management system 108 on the side of vendor 101, and the authorized user is only permitted for access due to the security function of the host management system 108. Specifically, via the Internet 105, the status information (e.g., the symptom of the manufacturing apparatus having caused a trouble) indicating the operating condition of each manufacturing apparatus 106 is notified from the plant side to the vendor side, the response information (e.g., the information instructing a method for coping with the trouble, or the software or data for countermeasure) to its notification, or the maintenance information such as the latest software and help information can be received from the vendor side. A communication protocol (TCP/IP) that is commonly utilized in the Internet is employed for the data communication between each plant 102 to 104 and the vendor 101 or in the LAN 111 within each plant. Instead of employing the Internet as the external network outside the plant, a private line network (e.g., ISDN) with high security which can not be accessed from the third party is available. Also, the host management system is not limited to that provided by the vendor, but the user may construct a database and install it on the external network, and access to the database from a plurality of plants for the user may be permitted.

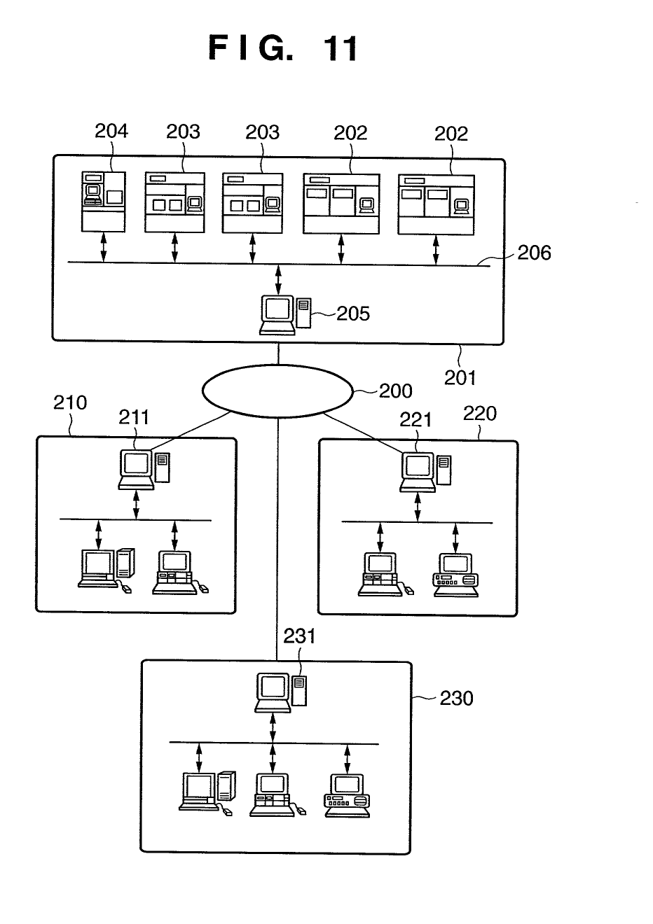

FIG. 11 is a concept view representing an overall system of this embodiment cut out from another angle. In the previous example, the user plants each having the manufacturing apparatus are connected with the management system for the vendor of the manufacturing apparatus via an external network, wherein it is possible to make the production management of each plant and the data communication for at least one manufacturing apparatus via the external network. In contrast, in this example, a plant comprising the manufacturing apparatus for a plurality of vendors is connected with plural manufacturing apparatus, and the management system for each vendor via the external network, in which the maintenance information for each manufacturing apparatus is communicated. In FIG. 11, reference numeral 201 denotes a manufacturing plant for the manufacturing apparatus user (semiconductor device manufacturer), in which the manufacturing apparatus for performing various processes, for example, an exposure apparatus 202, a photo-lithography processor 203 and a film formation apparatus 204 are installed in a production line of the plant. In FIG. 11, one manufacturing plant 201 is drawn, but in practice a plurality of plants are similarly connected via the network. Each apparatus within the plant is connected via a LAN 206 to make up the Intranet, and a host management system 205 performs the operating management of the production line. On one hand, an exposure apparatus maker 210, a photo-lithography processor maker 220, a film formation apparatus maker 230 have the host management systems 211, 221, 231 for enabling the remote maintenance of the apparatus supplied at their business offices of the vendors (apparatus supplier), respectively, each host management system having a maintenance database and a gateway to the external network, as described above. A host management system 205 for managing each apparatus within the manufacturing plant of the user and the host management systems 211, 221 and 231 of the apparatus vendors are connected via the Internet that is the external network 200 or a private line network. In this system, if a trouble arises in any of the manufacturing apparatus in the production line, the operation of the production line will cease, but the prompt measure can be taken by accepting the remote maintenance from the vendor of the manufacturing apparatus having caused the trouble via the Internet 200, whereby the stop of the production line can be suppressed to the minimum.

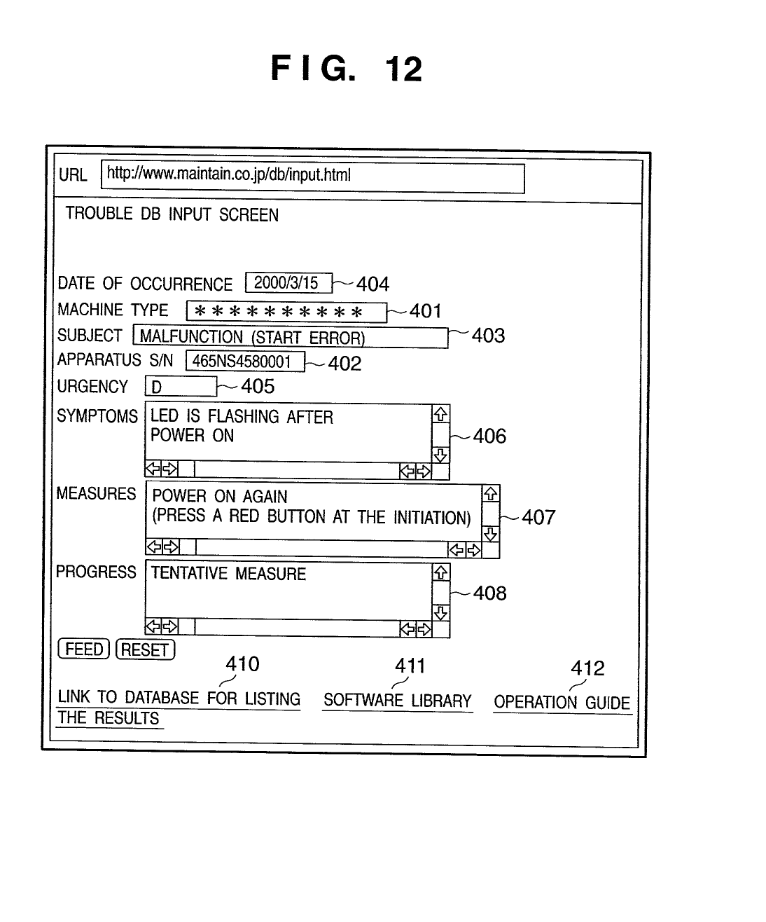

Each manufacturing apparatus installed in the semiconductor manufacturing plant has a computer with a display, a network interface, a software for network access and an operation software for the apparatus stored in a storage unit. The storage unit may be an internal memory, a hard disk or a network file server. The software for network access contains a private or general-purpose Web browser to provide a user interface with a screen as shown as an example in FIG. 12 on the display. The operator who manages the manufacturing apparatus in each plant can enter input items including, for the manufacturing apparatus, a type 401, a serial number 402, a subject matter of trouble 403, date of occurrence 404, urgency 405, symptoms 406, measures 407, progress 408 on the screen. The input information is transmitted via the Internet to the maintenance database, so that the appropriate maintenance information is sent back from the maintenance database, and appears on the display. Also, the user interface provided by the Web browser implements the hyper-link functions 410, 411 and 412 as illustrated in the figure, whereby the operator can gain access to the detailed information of each item, draw out the software in the latest version used for the manufacturing apparatus from the software library provided by the vendor, or draw out the operation guide (help information) to be referenced by the operator of the plant. Herein, the maintenance information provided by the maintenance database includes the information concerning the present invention as described above, and the software library also provides the latest software for realizing the present invention.

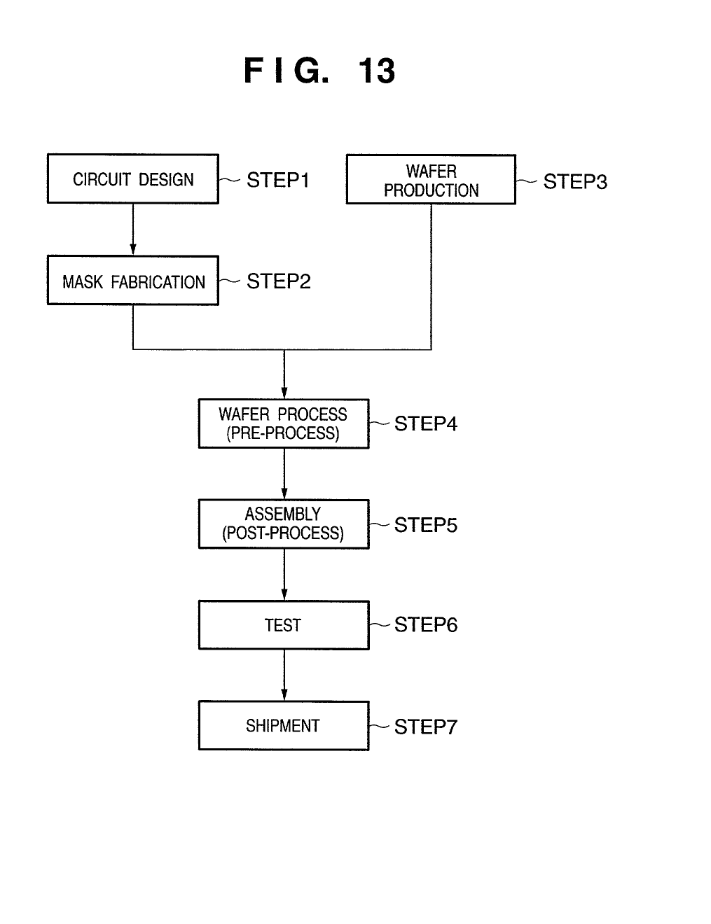

A manufacturing process for the semiconductor devices employing the production system as described above will be set forth below. FIG. 13 shows an overall flow of the manufacturing process for the semiconductor devices. At step 1 (circuit design), a circuit design of semiconductor device is made. At step 2 (mask fabrication), a mask formed with the designed circuit pattern is made. On the other hand, at step 3 (wafer fabrication), a wafer is produced employing a silicone material. Step 4 (wafer process) is referred to as a preprocess, in which an actual circuit is formed on the wafer by lithography technique, employing the mask and wafer prepared. The next step 5 (assembly) is referred to as a post-process, in which a semiconductor chip is produced, employing the wafer fabricated at step 4, and the step 5 includes an assembly sub-step (dicing, bonding) and a packaging sub-step (chip sealing) for effect the assembling. At step 6 (test), an operation check test and a durability test for the semiconductor device fabricated at step 5 are conducted. Through the above steps, the semiconductor device is completed, and shipped (step 7). The preprocess and the postprocess are conducted in separate dedicated plants, each of which is maintained by the remote maintenance system as described above. Also, between the preprocess plant and the postprocess plant, the information for the production management or the apparatus maintenance is communicated via the Internet or the private line network.

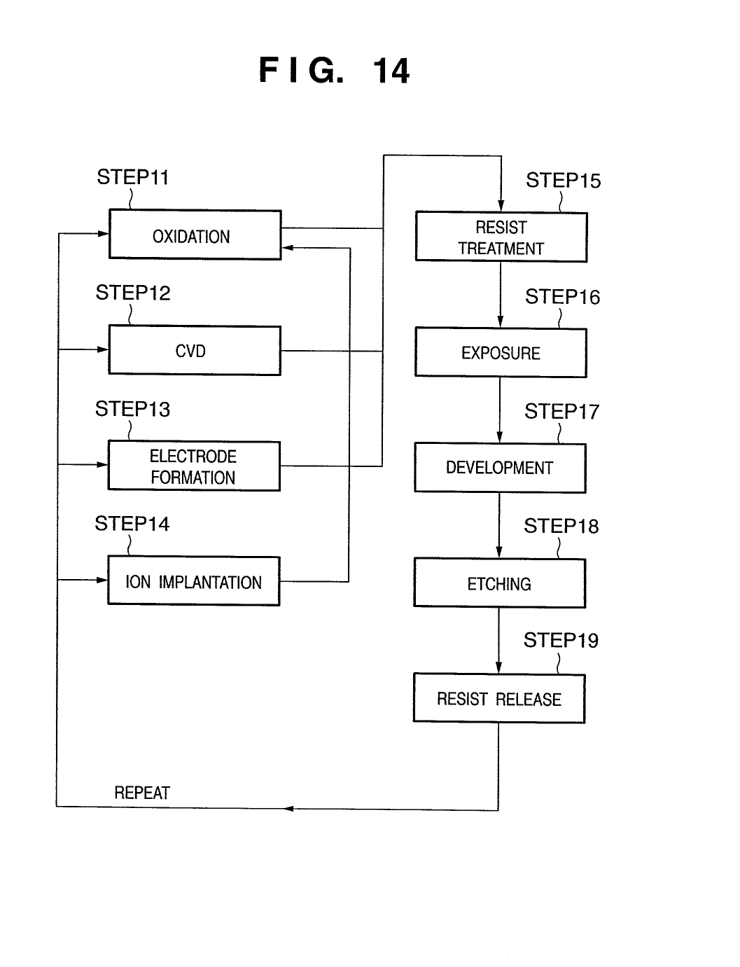

FIG. 14 shows a detailed flow of the wafer process. At step 1 (oxidation), the surface of wafer is oxidized. At step 12 (CVD), an insulating film is formed on the surface of wafer. At step 13 (electrode formation), an electrode is formed on the wafer by vapor deposition. At step 14 (ion implantation), ions are implanted into the wafer. At step 15 (resist treatment), a photosensitive agent is coated on the wafer. At step 16 (exposure), a circuit pattern of mask is printed and exposed by the exposure apparatus. At step 17 (development), the exposed wafer is developed. At step 18 (etching), a portion other than a resist image developed is etched away. At step 19 (resist release), the unnecessary resist after etching is removed. By repeating the above steps, multiple circuit patterns are formed on the wafer. Since the manufacturing apparatus for use with each step is maintained by the remote maintenance system as described previously, it is possible to prevent the trouble from occurring, and even if the trouble occurs, the prompt recovery can be effected, resulting in the greater productivity of the semiconductor devices than conventionally.

As detailed above, the following effects can be obtained by the active vibration isolator, the method for calculating the mode matrix, and the exposure apparatus for controlling the vibration isolation with this method.

(1) In the conventional active vibration isolator, the damping was given for each motion mode. Accordingly, if the adjustment of damping was performed for each motion mode, the over-damping might be given. However, with this invention, it is possible to provide the damping individually to an intrinsic vibration mode separated from individual coupled vibrations. Accordingly, since there is no situation that the damping is given to the adjacent motion modes, as with the conventional case, a danger of over-damping can be avoided, bringing about the effect that the attitude of the table for vibration isolating can be adjusted suitably.

(2) As a consequence, the precision mechanical apparatus mounted on the table for vibration isolating supported by the active vibration isolator, for example, a stage, has a higher positioning precision and a shorter settling time. Also, there is the effect that the mechanical resonance that the precision measuring apparatus mounted on the table for vibration isolating has is not excited inadvertently.

(3) All the vibration modes for the table for vibration isolating supported by the active support leg can be excited.

(4) Accordingly, the mode matrix φ can be obtained at higher precision with less efforts for calculating the mode matrix φ.

(5) The non-interacting control system for each vibration mode can be made up employing the mode matrix at high precision based on the result of actual measurements. Namely, the non-interacting control system for each vibration mode reflecting the characteristics of the actual machine faithfully can be constructed for the active vibration isolator.

(6) The effective adjustment for the active vibration isolator particularly contributes to the improved settlement for positioning the XY stage mounted on the active vibration isolator. Thereby, there is the effect that the productivity of the exposure apparatus is increased.

As many apparently widely different embodiments of the present invention can be made without departing from the spirit and scope thereof, it is to be understood that the invention is not limited to the specific embodiments thereof except as defined in the claims.

What is claimed is:

1. An active vibration isolator comprising:
a table for vibration isolating;
a plurality of actuators for driving said table for vibration isolating;
a plurality of vibration sensor for detecting a vibration of said table for vibration isolating; and
a plurality of position sensor for detecting a displacement of said table for vibration isolating,
wherein said table for vibration isolating is actively damped by driving said plurality of actuators on the basis of a state quantity fed back through a vibration control loop for each vibration mode that is non-interacting on the basis of the outputs of said vibration sensor, and a position control loop for each motion mode on the basis of the outputs of said position sensor and damping said vibration mode that is non-interacting.

2. The active vibration isolator according to claim 1, further comprising vibration mode extracting calculator for converting an motion mode acceleration signal into a vibration mode acceleration signal, and vibration mode distributing calculator for converting into a drive signal for giving rise to damping for an motion mode, wherein damping can be effected for each vibration mode.

3. The active vibration isolator according to claim 1, wherein said plurality of actuators comprise a plurality of air spring actuators and a plurality of electromagnetic actuators, said electromagnetic actuators being driven through said vibration control loop for each vibration mode, and said air spring actuators being driven through said position control loop for each motion mode.

4. The active vibration isolator according to claim 1, wherein said plurality of actuators comprise a plurality of air spring actuators, said air spring actuators being driven through said vibration control loop for each vibration mode, and through said position control loop for each motion mode.

5. The active vibration isolator according to claim 1, wherein said vibration sensor is an acceleration sensor or a velocity sensor.

6. The active vibration isolator according to claim 1, further comprising a mode calculator for calculating a mode matrix of said each vibration mode based on at least one detection result of said vibration sensor and said position sensor.

7. The active vibration isolator according to claim 6, wherein said mode calculator measures a time response waveform of said table for vibration isolating to an input of a pseudo impulse by said vibration sensor or said position sensor, analyzes frequencies of the time response waveform, and calculates the mode matrix of said table for vibration isolating from said frequencies analysis.

8. The active vibration isolator according to claim 6, wherein the time width of the pseudo impulse is a spectrum for applying an equal excitation force in the vibration mode for said table for vibration isolating supported by said actuators.

9. The active vibration isolator according to claim 6, wherein said mode calculator measures a response to said vibration sensor or said position sensor as a frequency response from a sweep sinusoidal wave signal, calculates a parameter in a dynamic system with one degree of freedom to convert said frequency response into a Nyquist diagram and make curve fitting to a number of circles equal to at least the number of vibration modes for said table for vibration isolating appearing in said Nyquist diagram, and calculates the mode matrix from the result of said curve fitting.

10. The active vibration isolator according to claim 1, wherein said actuator includes an electromagnetic actuator.

11. The active vibration isolator according to claim 6, further comprising:
vibration mode extracting calculator for extracting a vibration mode of said table for vibration isolating from the outputs of said plurality of vibration sensor; and
vibration mode distributing calculator for distributing a signal with an output of said vibration mode extracting means compensated appropriately to said actuators,
wherein the compensation for the output of said vibration mode extracting means by said vibration mode distributing calculator is adjustment of damping for a resonance peak of each vibration mode on the basis of said calculated mode matrix.

12. An exposure apparatus for transferring a circuit pattern formed on an original plate via a projection optical system onto a photosensitive substrate on a substrate stage, comprising an active vibration isolator in said exposure apparatus, wherein said active vibration isolator comprises:
a table for vibration isolating;
a plurality of actuators for driving said table for vibration isolating;
a plurality of vibration sensor for detecting a vibration of said table for vibration isolating; and
a plurality of position sensor for detecting a displacement of said table for vibration isolating,
wherein said table for vibration isolating is actively damped by driving said plurality of actuators on the basis of a state quantity fed back through a vibration control loop for each vibration mode that is non-interacting on the basis of the outputs of said vibration sensor, and a position control loop for each motion mode on the basis of the outputs of said position sensor and damping said vibration mode that is non-interacting.

13. A method for manufacturing semiconductor devices comprising:
a step of installing a plurality of manufacturing apparatus for semiconductor process including an exposure apparatus in a semiconductor plant; and
a step of manufacturing semiconductor devices with said plurality of manufacturing apparatus for semiconductor process that are installed;
wherein said exposure apparatus comprises an active vibration isolator,
wherein said active vibration isolator comprises:
a table for vibration isolating;
a plurality of actuators for driving said table for vibration isolating;
a plurality of vibration sensor for detecting a vibration of said table for vibration isolating; and
a plurality of position sensor for detecting a displacement of said table for vibration isolating,
wherein said table for vibration isolating is actively damped by driving said plurality of actuators on the basis of a state quantity fed back through a vibration control loop for each vibration mode that is non-interacting on the basis of the outputs of said vibration sensor, and a position control loop for each motion mode on the basis of the outputs of said position sensor and damping said vibration mode that is non-interacting.

14. The method for manufacturing semiconductor devices according to claim 13, further comprising:
a step of connecting the semiconductor manufacturing apparatus having said exposure apparatus via a local area network;
a step of connecting said local area network with an external network outside said semiconductor manufacturing plant;
a step of acquiring the information concerning said exposure apparatus from a database on said external network, employing said local area network and said external network; and
a step of controlling said exposure apparatus on the basis of said acquired information.

15. The method for manufacturing semiconductor devices according to claim 13, further comprising acquiring the maintenance information of said manufacturing apparatus in the data communication by gaining access to a database provided by the bender or the user of said exposure apparatus via said external network, or making the production management in the data communication via said external network with another semiconductor manufacturing plant that is different from said semiconductor manufacturing plant.

16. A semiconductor manufacturing plant comprising:
a plurality of semiconductor manufacturing apparatus for process including an exposure apparatus;
a local area network for connecting between said semiconductor manufacturing apparatus; and
a gateway for connecting said local area network and an external network outside said semiconductor manufacturing plant,
wherein the information concerning at least one of said semiconductor manufacturing apparatus can be conveyed in the data communication,
wherein said exposure apparatus included in said semiconductor manufacturing apparatus comprises an active vibration isolator,
said active vibration isolator comprising:
a table for vibration isolating;
a plurality of actuators for driving said table for vibration isolating;
a plurality of vibration sensor for detecting a vibration of said table for vibration isolating; and
a plurality of position sensor for detecting a displacement of said table for vibration isolating,
wherein said table for vibration isolating is actively damped by driving said plurality of actuators on the basis of a state quantity fed back through a vibration control loop for each vibration mode that is non-interacting on the basis of the outputs of said vibration sensor, and a position control loop for each motion mode on the basis of the outputs of said position sensor and damping said vibration mode that is non-interacting.

17. A maintenance method for an exposure apparatus comprising:
a step of preparing a database storing the information concerning the maintenance of said exposure apparatus on an external network outside a plant where the exposure apparatus is installed;
a step of connecting said exposure apparatus to a local area network inside said plant; and
a step of performing the maintenance of the exposure apparatus on the basis of the information stored in said database, employing said external network and said local area network,
wherein said exposure apparatus comprises an active vibration isolator,
wherein said active vibration isolator comprises:
a table for vibration isolating;
a plurality of actuators for driving said table for vibration isolating;
a plurality of vibration sensor for detecting a vibration of said table for vibration isolating; and
a plurality of position sensor for detecting a displacement of said table for vibration isolating,
wherein said table for vibration isolating is actively damped by driving said plurality of actuators on the basis of a state quantity fed back through a vibration control loop for each vibration mode that is non-interacting on the basis of the outputs of said vibration sensor, and a position control loop for each motion mode on the basis of the outputs of said position sensor and damping said vibration mode that is non-interacting.

18. The exposure apparatus according to claim 12, further comprising an interface for effecting connection with the network, a computer for executing a network software for performing the data communication of the maintenance information of said exposure apparatus via said network, and a display for displaying the maintenance information of said exposure apparatus that is communicated in accordance with the network software executed by said computer.

19. The exposure apparatus according to claim 18, wherein said network software provides a user interface for gaining access to the maintenance database connected to the external network of the plant where said exposure apparatus is installed and provided by the vendor or the user of said exposure apparatus, on the display, making it possible to acquire the information from said database via said external network.
